(19) United States
(12) Patent Application Publication
(10) Pub. No.: US 2024/0185183 A1
(43) Pub. Date: Jun. 6, 2024

(54) SYSTEM AND PROCESS FOR A REAL-TIME PROJECT MANAGEMENT PLATFORM

(71) Applicant: CYRIAC ABRAHAM, HOUSTON, TX (US)

(72) Inventor: CYRIAC ABRAHAM, HOUSTON, TX (US)

(21) Appl. No.: 18/531,683

(22) Filed: Dec. 6, 2023

Related U.S. Application Data
(60) Provisional application No. 63/386,235, filed on Dec. 6, 2022.

(51) Int. Cl. G06Q 10/10

(52) U.S. Cl. CPC G06Q 10/103

(57) ABSTRACT

A computer implemented project management application is disclosed. The application can include a method for prioritizing for a current day each respective activity of a plurality of daily activities identified for a project. The application can include a method for resizing a size, shape, or configuration of an object used in a construction project. The application can include a method for selecting activities and resources for a project comprising a plurality of activities and a plurality of resources.

### CROSS-REFERENCE TO RELATED APPLICATIONS

This application claims the benefit of priority under 35 U.S.C. § 119(e) of U.S. Provisional Application Ser. No. 63/386,235, filed on Dec. 6, 2022, the content of which is relied upon and incorporated herein by reference in its entirety.

### FIELD

The present disclosure generally relates to computer software, and more specifically to project management software, and even more specifically to a real-time project management software for the construction industry.

### BACKGROUND

A project is a temporary human endeavor to create a product, service, or result. Project management often involves a plurality of action steps, each of independent duration; and a plurality of decision points distributed over time and geographical locations. A decision point may be reached after the performance one or more action steps by different persons or equipment. Project management is a complex process because of the number of people, equipment, and entities involved and their dependence on each other as well as the differences or even conflicts of interests among the parties. Modern projects can spread over multiple geographies and time zones and executed by project participants of varied social and cultural backgrounds.

Existing project management software products rely on a library of templates to develop the information required to construct an object (e.g., building). But such software has no ability to modify the template other than using manual data input. Accordingly, there remains a need for project management software that can provide users, including project managers, with the data and information needed to complete a successful project.

### SUMMARY

In various embodiments, a computer implemented method for prioritizing for a current day each respective activity of a plurality of daily activities identified for a project is provided. The some embodiments, the method comprises: providing an application platform for carrying out the method, wherein the application platform comprises a database with a first list comprising the plurality of daily activities, wherein each respective activity has a plurality of attributes; identifying each activity of the plurality of daily activities having an early start attribute defined as the current day and storing each of the identified activities in a second list for the current day; identifying and storing each activity in the second list having a continuing activity attribute and storing the same in a third list for continuing activities for the current day; identifying and storing each activity in the second list having a non-continuing activity attribute and storing the same in a fourth list for non-continuing activities for the current day; grading each activity in the third list based on its total float attribute, wherein the grading is one of TF<0; TF=0; and TF>0; and storing the activities for each grade in a fifth list, sixth list, and seventh list, respectively; grading each activity in the fourth list based on its total float attribute, wherein the grading is one of TF<0; TF=0; and TF>0; and storing the activities for each grade in an eighth list, nineth list, and tenth list, respectively; identifying each activity in the fifth list having a not breakable attribute and storing the activities in an eleventh list for first highest priority; identifying each activity in the sixth list having a not breakable attribute and storing the activities in a twelfth list for second highest priority; identifying each activity in the seventh list having a not breakable attribute and storing the activities in a thirteenth list for third highest priority; and presenting the activities for the first highest priority, second highest priority, and third highest priority on a user interface according to their respective priority ranking.

In some embodiments, the method further comprises: identifying each activity in the eighth list having a not breakable attribute and storing the activities in an eleventh list for fifth highest priority; identifying each activity in the ninth list having a not breakable attribute and storing the activities in a twelfth list for eighth highest priority; identifying each activity in the tenth list having a not breakable attribute and storing the activities in a thirteenth list for eleventh highest priority; and presenting the activities for the fifth highest priority, eighth highest priority, and eleventh highest priority on the user interface according to their respective priority ranking.

In some embodiments, the method further comprises: identifying each activity in the fifth list having a breakable attribute and storing the activities in an eleventh list for fourth highest priority; identifying each activity in the sixth list having a breakable attribute and storing the activities in a twelfth list for seventh highest priority; identifying each activity in the seventh having a breakable attribute and storing the activities in a thirteenth list for tenth highest priority; and presenting the activities for the fourth highest priority, seventh highest priority, and tenth highest priority on the user interface according to their respective priority ranking.

In some embodiments, the method further comprises: identifying each activity in the eighth list having a breakable attribute and storing the activities in an eleventh list for sixth highest priority; identifying each activity in the ninth list having a breakable attribute and storing the activities in a twelfth list for ninth highest priority; identifying each activity in the tenth list having a breakable attribute and storing the activities in a thirteenth list for twelfth highest priority; and presenting the activities for the sixth highest priority, ninth highest priority, and twelfth highest priority on the user interface according to their respective priority ranking.

In some embodiments, a computer implemented method for resizing a size, shape, or configuration of an object used in a construction project is provided. In some embodiments, the method comprises: providing an application platform for carrying out the method, wherein the application platform comprises a resizing engine and a database comprising a plurality of objects, and wherein each object has a plurality of attributes; presenting the object on a user interface; identifying one or more attributes of the object for resizing; applying one or more resize factors to the respective one or more attributes of the object, wherein each respective resize factor is a multiplier; storing the resized object to the database; and presenting the resized object on the user interface.

In some embodiments, a plurality of the one or more attributes of the object are resized in sequence.

In some embodiments, a plurality of the one or more attributes of the object are resized in parallel.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, explain the principles and operations of the claimed subject matter.

### BRIEF DESCRIPTION OF THE DRAWINGS

A complete understanding of the present embodiments and the advantages and features thereof will be more readily understood by reference to the following detailed description, appended claims, and accompanying drawings, wherein:

FIG. 1 is a block diagram of a computing system, in accordance with embodiments described herein;

FIG. 2 is a block diagram of an application program that is executable by the computing system of FIG. 1;

FIG. 3 is a block diagram of the application program in FIG. 2;

FIGS. 4A, 4B, and 4C are block diagrams showing the deployment of servers, in accordance with embodiments described herein;

FIG. 5 is a diagram showing a building block object being resized, in accordance with embodiments described herein;

FIG. 6 is a diagram showing the breakdown of a building block into its various activities, in accordance with embodiments described herein;

FIG. 7 is a flowchart of a process carried out by an activity selector, in accordance with embodiments described herein;

FIG. 8 is a flowchart of a process carried out by a process driver, in accordance with embodiments described herein;

FIG. 9 is a flowchart of a process carried out by the project success evaluator, in accordance with embodiments described herein;

FIG. 10 is a flowchart of a process carried out by the finance interest saver, in accordance with embodiments described herein;

FIG. 11 is a diagram of an Activity Dimension Rating, in accordance with embodiments described herein;

FIG. 12 is a diagram of an Activity Performance Score, in accordance with embodiments described herein;

FIG. 13 is a diagram of an Activity Performance Award, in accordance with embodiments described herein;

FIG. 14 is a diagram of a Product Dimension Rating, in accordance with embodiments described herein;

FIG. 15 is a diagram of a Project Dimension, Project Dimension Weightage, Project Dimension Rating, Project Dimension Score, and Project Performance Score, in accordance with embodiments described herein;

FIG. 16 is a diagram of a Project Performance Award, in accordance with embodiments described herein;

FIG. 17 illustrates a graphical user interface showing the Building Block library on the left side and the working project area on the right side, in accordance with embodiments described herein;

FIG. 18 illustrates a graphical user interface showing the building block being resized, in accordance with embodiments described herein;

FIG. 19 illustrates a graphical user interface showing a sequence of activities for a building block, in accordance with embodiments described herein;

FIG. 20 illustrates a graphical user interface showing the aggregation of data contained in a work breakdown structure, in accordance with embodiments described herein;

FIG. 21 illustrates a graphical user interface showing the content associated with a building block activity, in accordance with embodiments described herein;

FIG. 22 illustrates a graphical user interface showing the content associated with a building block activity, in accordance with embodiments described herein;

FIG. 23 illustrates a graphical user interface showing the activities contained in a building block, in accordance with embodiments described herein;

FIG. 24 illustrates a graphical user interface showing content contained in an activity, in accordance with embodiments described herein;

FIG. 25 illustrates a graphical user interface showing the content associated with a building block activity, in accordance with embodiments described herein;

FIG. 26 illustrates a graphical user interface showing the content associated with a building block activity, in accordance with embodiments described herein;

FIG. 27 illustrates a graphical user interface showing the heat map dashboard, in accordance with embodiments described herein;

FIG. 28 illustrates a graphical user interface showing a customization of the dashboard based on performance, in accordance with embodiments described herein;

FIG. 29 illustrates a graphical user interface showing a customization of the dashboard by projects or portfolios, in accordance with embodiments described herein;

FIG. 30 illustrates a graphical user interface showing a change in the timing of the data: Today, Up-to-date, This Period, Estimate to Complete (ETC), and At Completion, in accordance with embodiments described herein;

FIG. 31 illustrates a graphical user interface showing various widgets, in accordance with embodiments described herein;

FIG. 32 illustrates a graphical user interface showing various widgets, in accordance with embodiments described herein;

FIG. 33 illustrates a graphical user interface showing various widgets, in accordance with embodiments described herein;

FIG. 34 illustrates a graphical user interface showing various widgets, in accordance with embodiments described herein;

FIG. 35 illustrates a graphical user interface showing various widgets, in accordance with embodiments described herein;

FIG. 36 illustrates a graphical user interface showing various widgets, in accordance with embodiments described herein;

FIG. 37 illustrates a graphical user interface showing various widgets, in accordance with embodiments described herein;

FIG. 38 illustrates a graphical user interface showing various widgets, in accordance with embodiments described herein;

FIG. 39 illustrates a graphical user interface showing the application of multiple criteria concurrently, in accordance with embodiments described herein; and

FIG. 40 illustrates a graphical user interface showing a report generated by the system, in accordance with embodiments described herein.

The drawings are not necessarily to scale, and certain features and certain views of the drawings may be shown exaggerated in scale or in schematic in the interest of clarity and conciseness.

### DETAILED DESCRIPTION

Reference will now be made in detail to the exemplary embodiment(s), examples of which is/are illustrated in the present disclosure. An embodiment refers to a particular feature or characteristic used in connection with a system or method step described herein. References to an “embodiment” appear throughout the disclosure, and such references are not necessarily referring to the same embodiment or to separate, mutually exclusive embodiment. Generally, the embodiments reside in combinations of components, subcomponents, and/or procedures related to the execution of a project management application program. Accordingly, the system and method components have been represented where appropriate, showing only those specific details that are pertinent to understanding the embodiments of the present disclosure so as not to obscure the disclosure with details that will be readily apparent to those of ordinary skill in the art having the benefit of the description herein. The specific details of the various embodiments described herein are used for demonstration purposes only, and no unnecessary limitation or inferences are to be understood therefrom.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure.

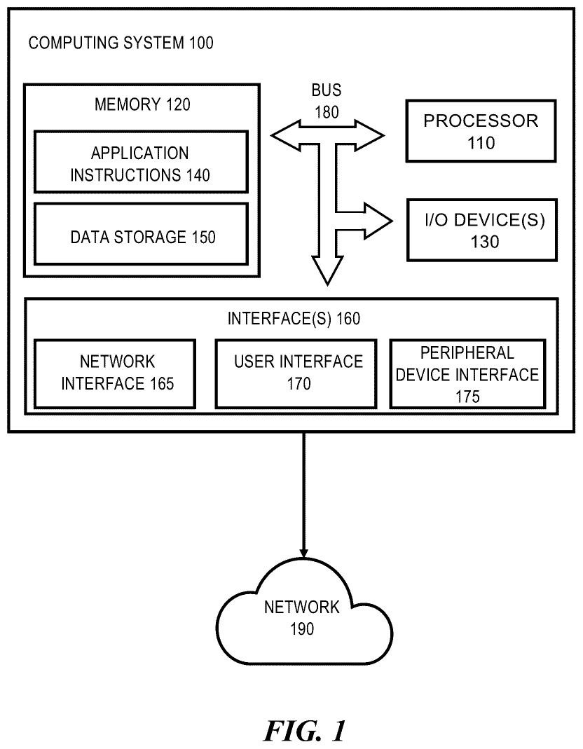

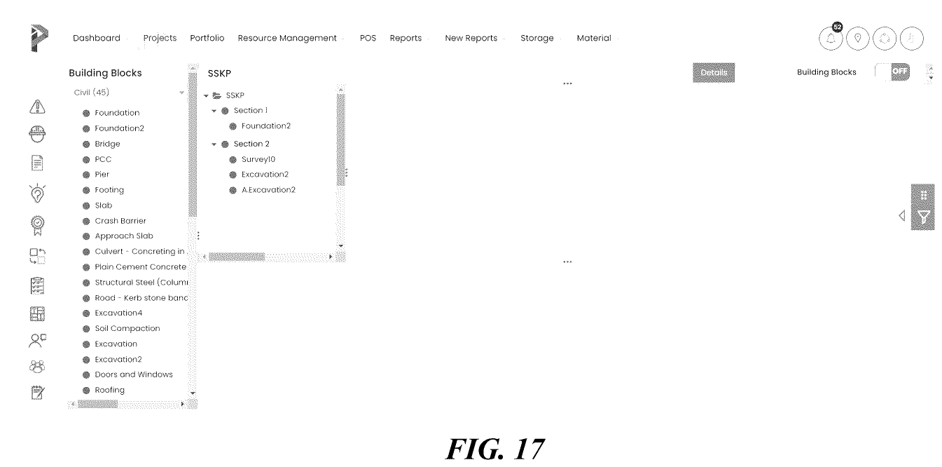

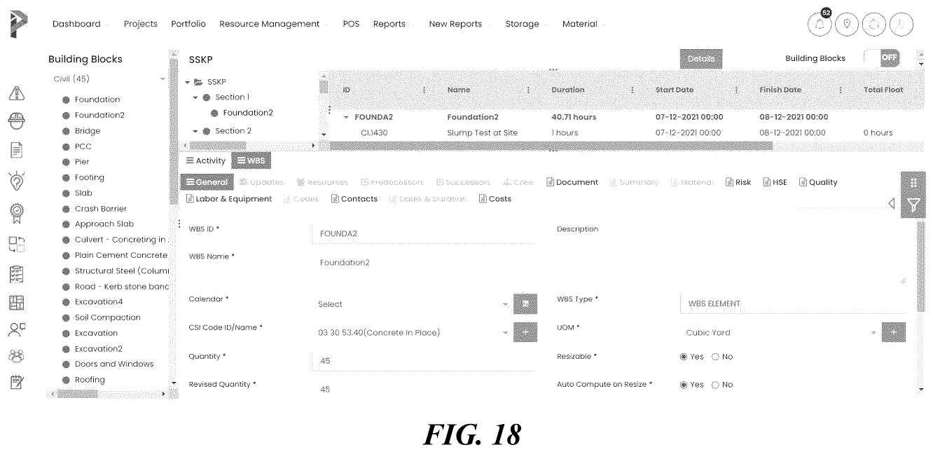

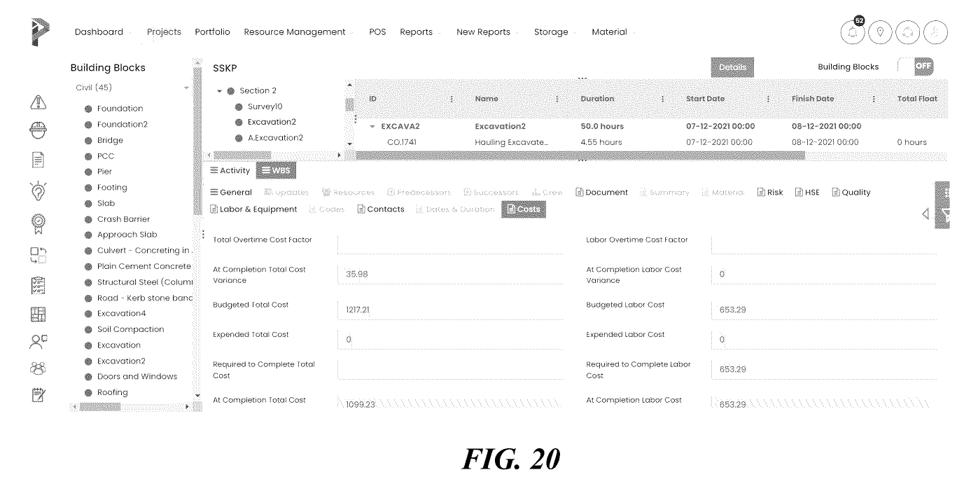

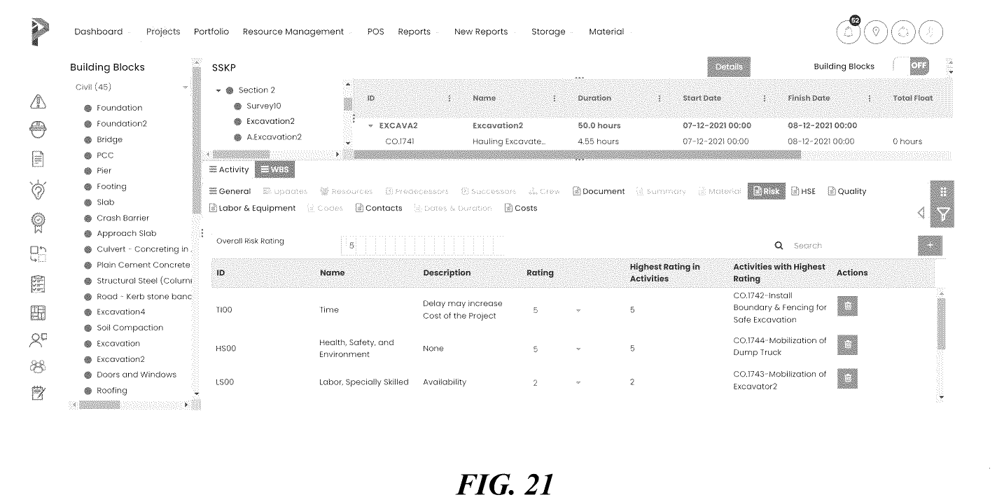

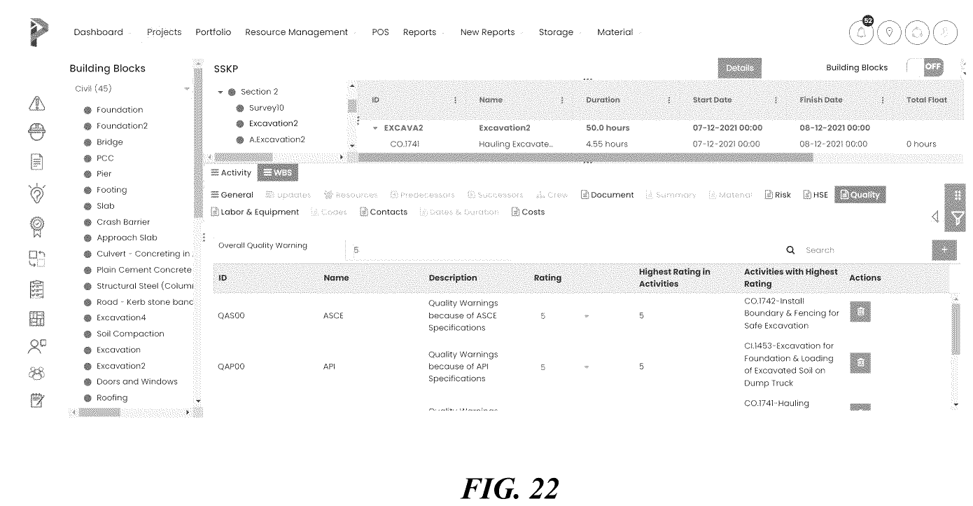

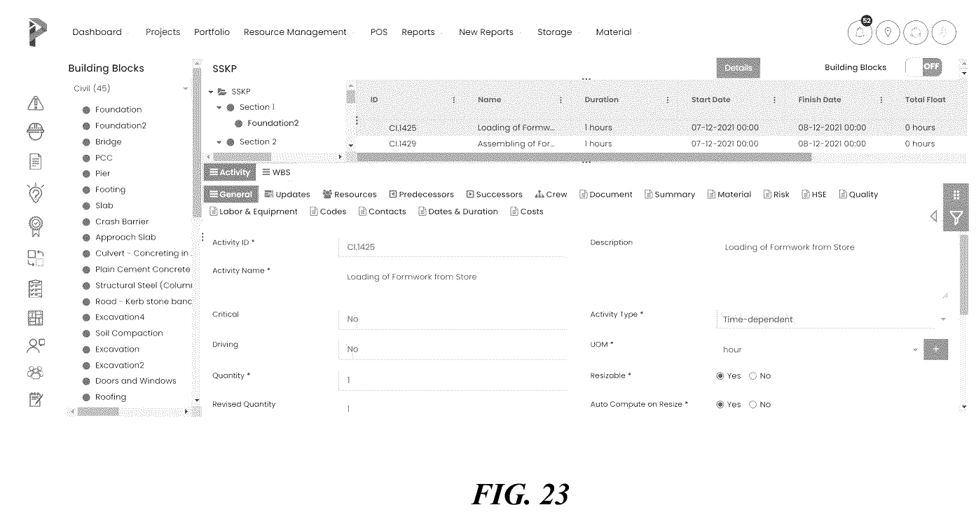

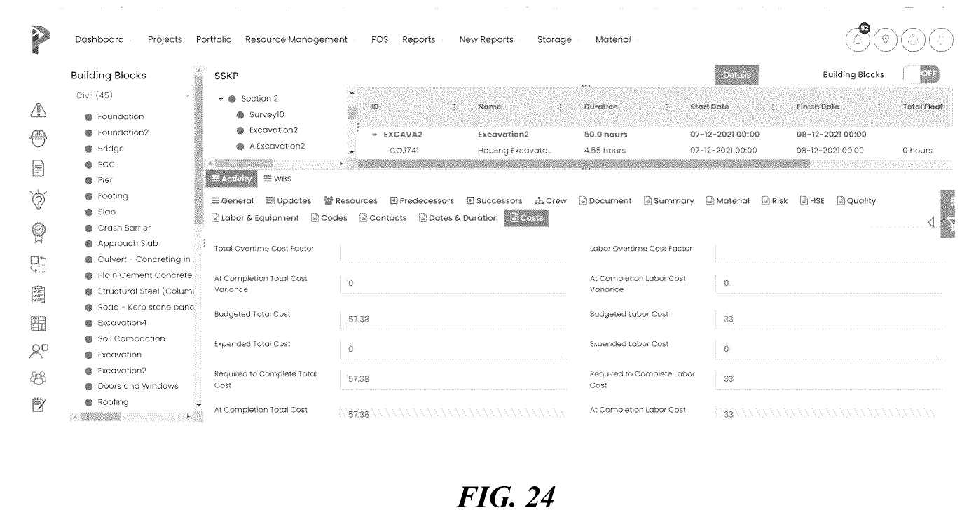

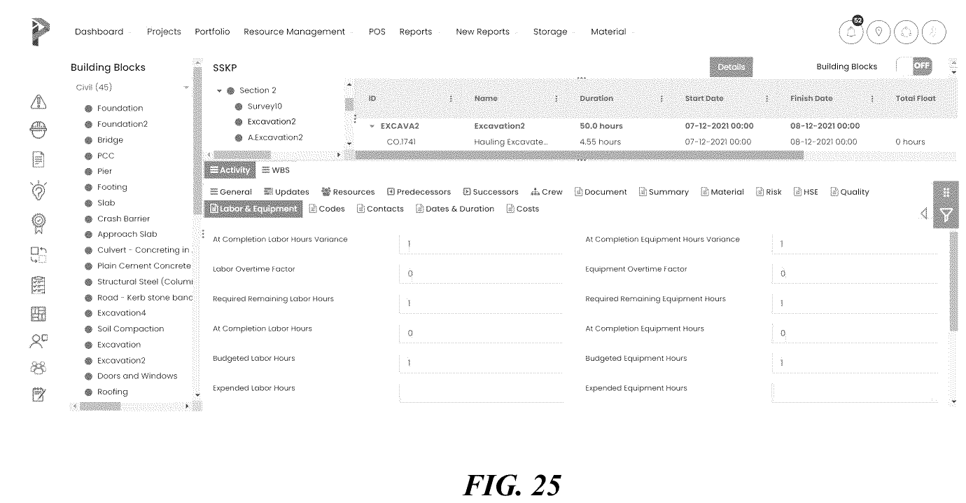

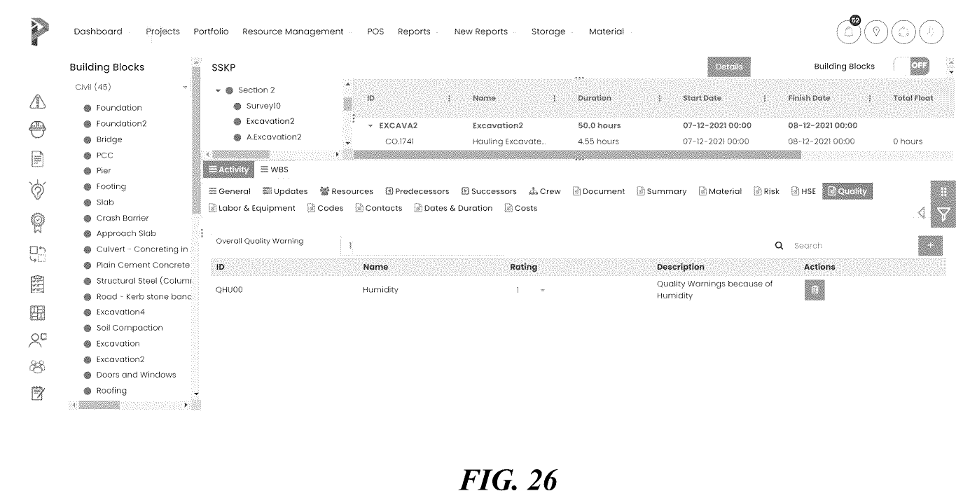

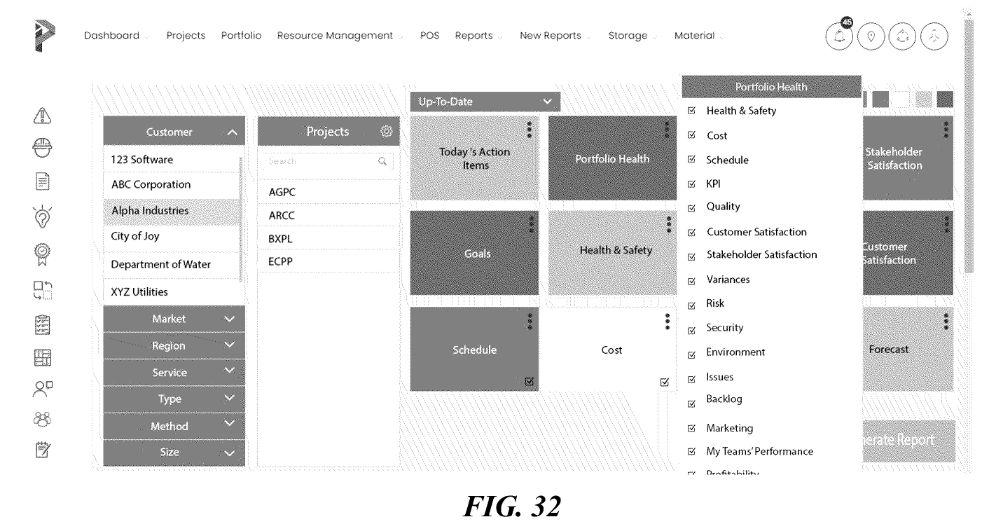

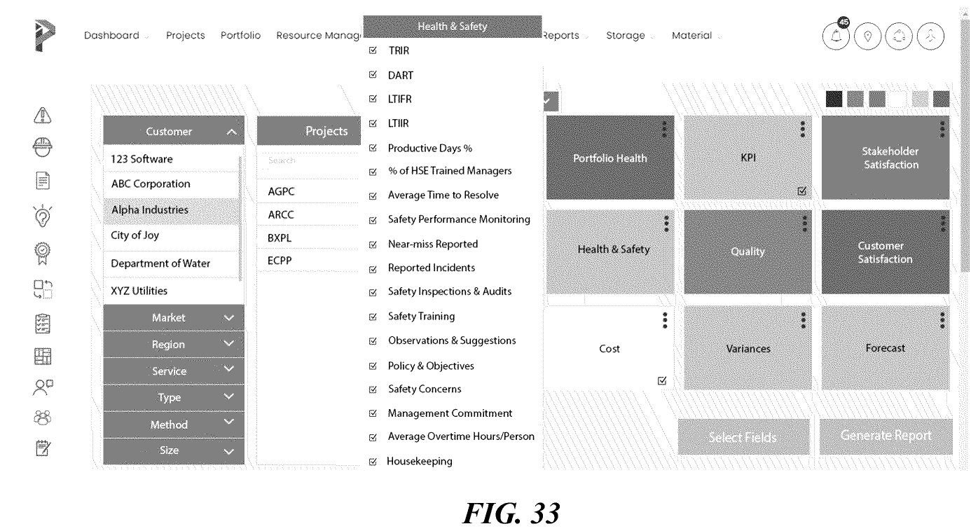

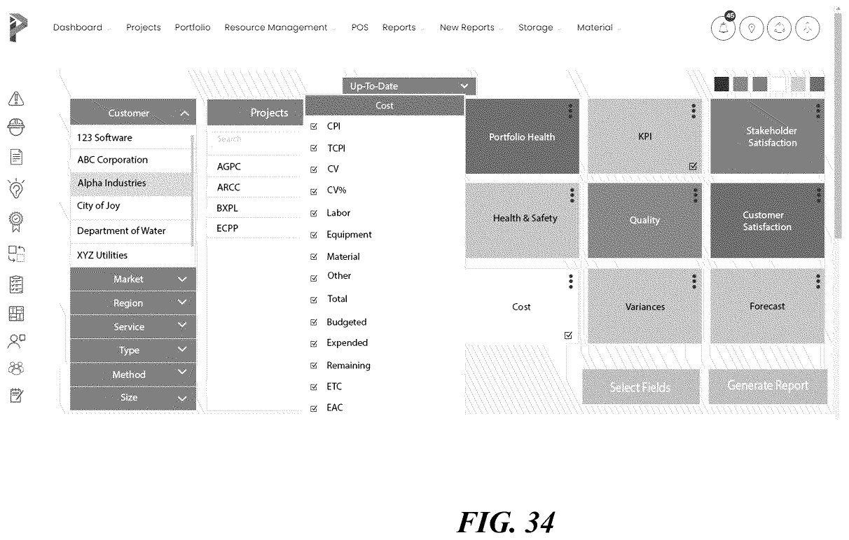

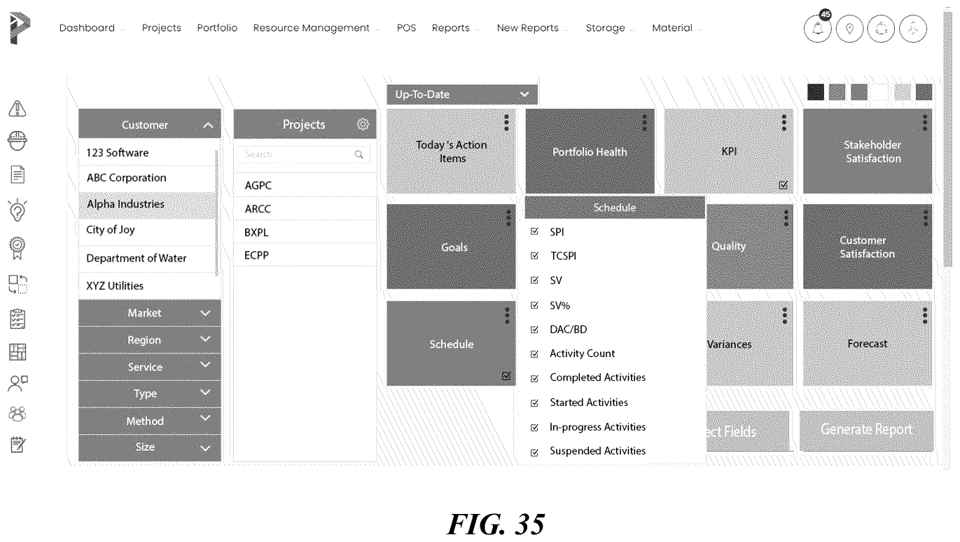

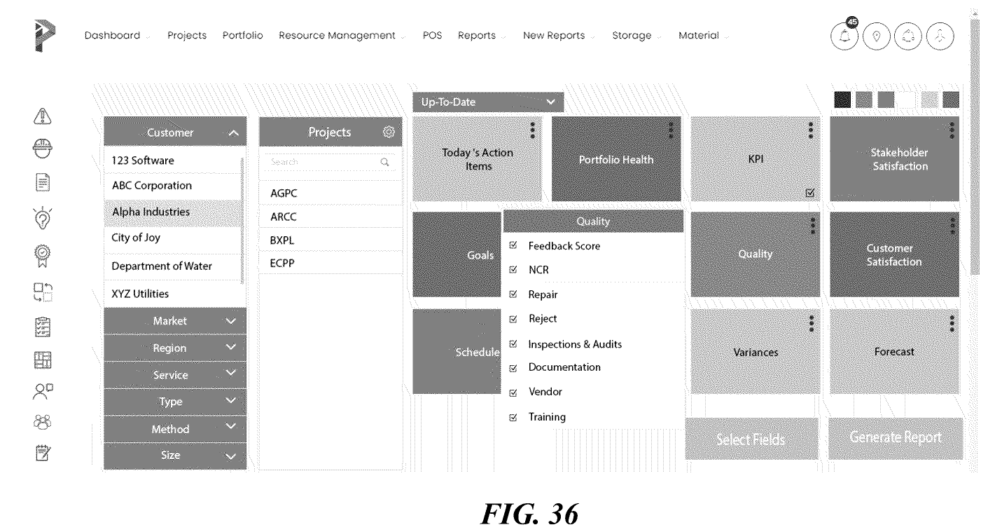

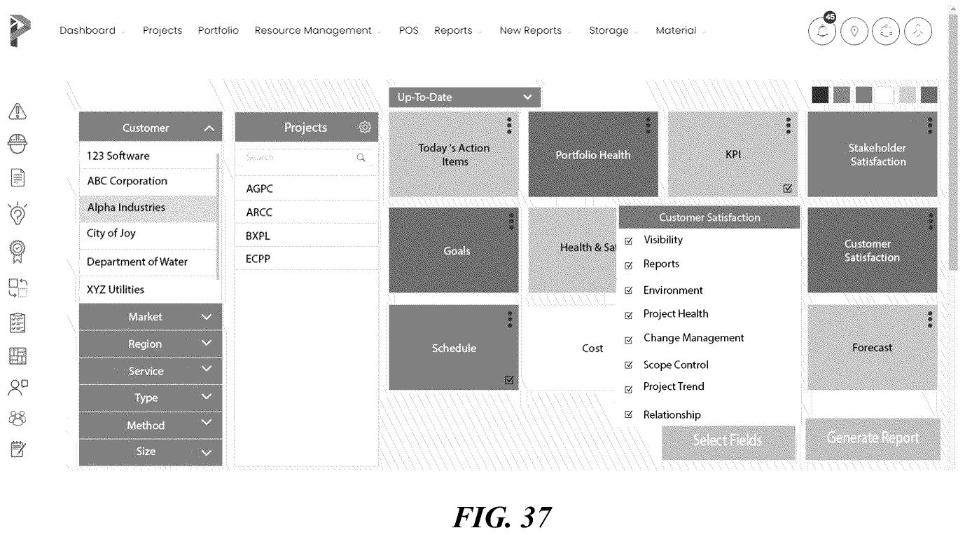

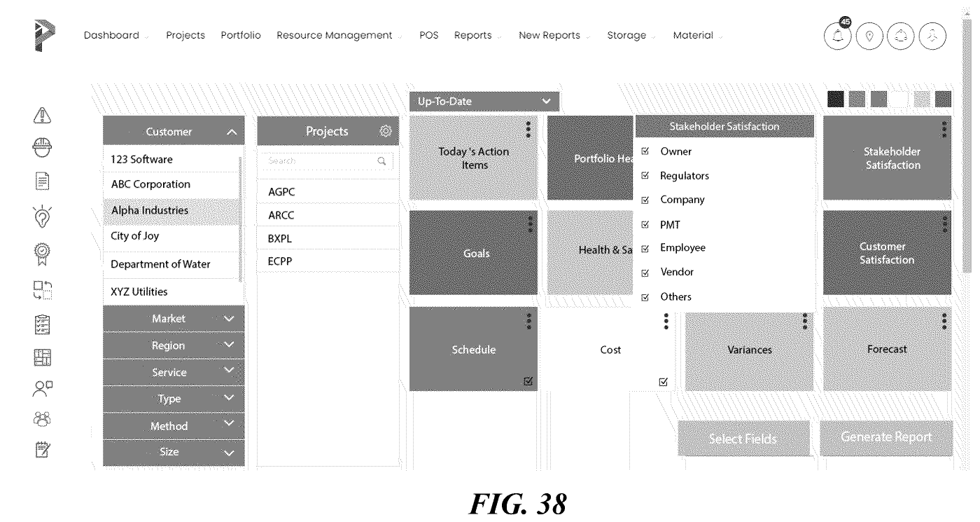

As shown in FIGS. 1-40, the embodiments in this disclosure relate to systems and processes for implementing a project management system.

FIG. 1 illustrates an example of a computing system 100 that may be utilized to execute various procedures, including the processes described herein. The computing system 100 comprises a standalone computer or mobile computing device, a mainframe computer system, a workstation, a network computer, a desktop computer, a laptop, or the like. The computing system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computing system 100 includes one or more processor(s) 110 coupled to a memory 120 through a system bus 180 that couples various system components, such as an input/output (I/O) device 130, to the processor 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computing system 100 includes one or more input/output (I/O) devices 130, such as video device(s) (e.g., a camera), audio device(s), and display(s) are in operable communication with the computing system 100. In some embodiments, similar I/O devices 130 may be separate from the computing system 100 and may interact with one or more nodes of the computing system 100 through a wired or wireless connection, such as over a network interface.

Processor 110 is suitable for the execution of computer readable program instructions include both general and special purpose microprocessors and any one or more processors of any digital computing device. For example, each processor 110 may be a single processing unit or a plurality of processing units, and may include a single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C #, JAVA, JAVASCRIPT, PERL, Angular, IOS, Android, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computing system 100 includes one or more interfaces 160 that allow the computing system 100 to interact with other systems, devices, or computing environments. In some embodiments, the computing system 100 comprises a network interface 165 to communicate with a network 190. In some embodiments, the network interface 165 is configured to allow data to be exchanged between the computing system 100 and other devices attached to the network 190, such as other computer systems, or between nodes of the computing system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computing system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

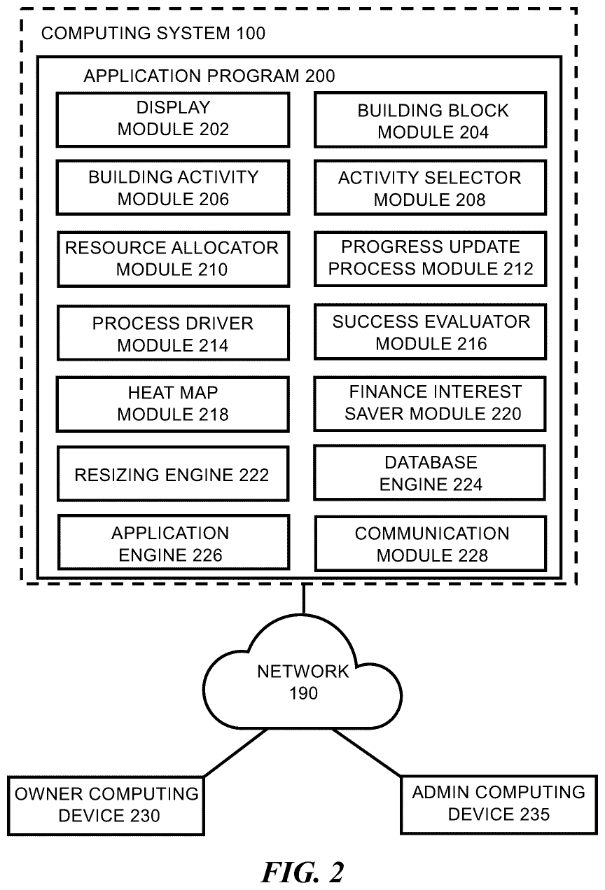

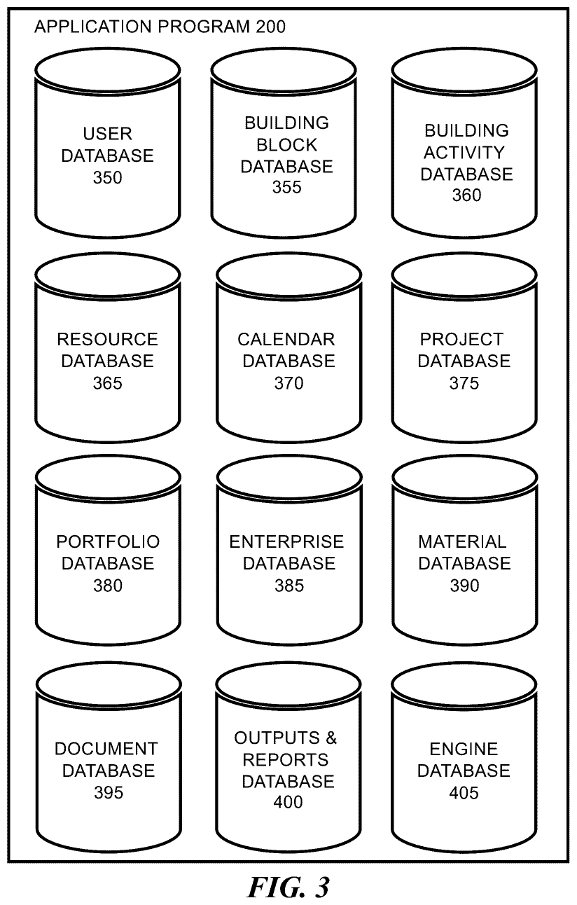

FIG. 2 and FIG. 3 illustrate an example computer architecture for the application program 200 described herein. FIG. 2 is a block diagram showing the module and engine components needed to perform the various specific tasks within the computing system 100. In particular, FIG. 2 shows the components of the application program 200, which comprises a plurality of modules and engines configured to implement the project management system described herein. FIG. 3 is a block diagram showing the one or more databases utilized by the various modules and engines in FIG. 2.

FIG. 2 illustrates a block diagram of an application program 200, which provides the components utilized to implement the project management system described herein. In some embodiments, the application program 200 comprises one or more of a display module 202, building block module 204, building activity module 206, activity selector module 208, resource allocator module 210, progress update process module 212, process driver module 214, success evaluator module 216, heat map module 218, finance interest saver module 220, resizing engine 222, database engine 224, and application engine 226, each of which are configured to work and communicate with one another. As shown in FIG. 2 the application program 200 is in communication with, via the network 190, one or more user computing device(s), including an owner/customer computing device 230 and/or administrator (“admin”) computing device 235.

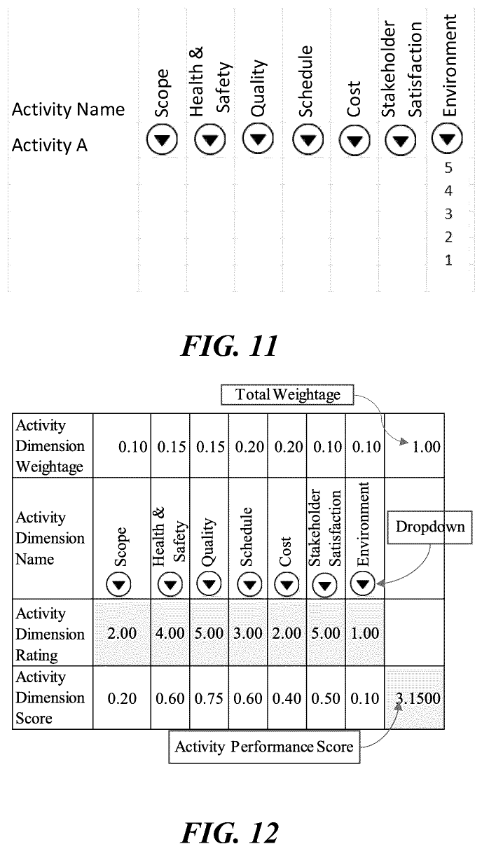

In some embodiments, the display module 202 is configured to display one or more graphic user interfaces as shown in, for example, FIGS. 11-40. In some embodiments, the display module 202 is configured to temporarily generate and display various pieces of information in response to one or more commands or operations. The various pieces of information or data generated and displayed may be transiently generated and displayed, and the displayed content in the display module 202 may be refreshed and replaced with different content upon the receipt of different commands or operations in some embodiments. In such embodiments, the various pieces of information generated and displayed in a display module 202 may not be persistently stored.

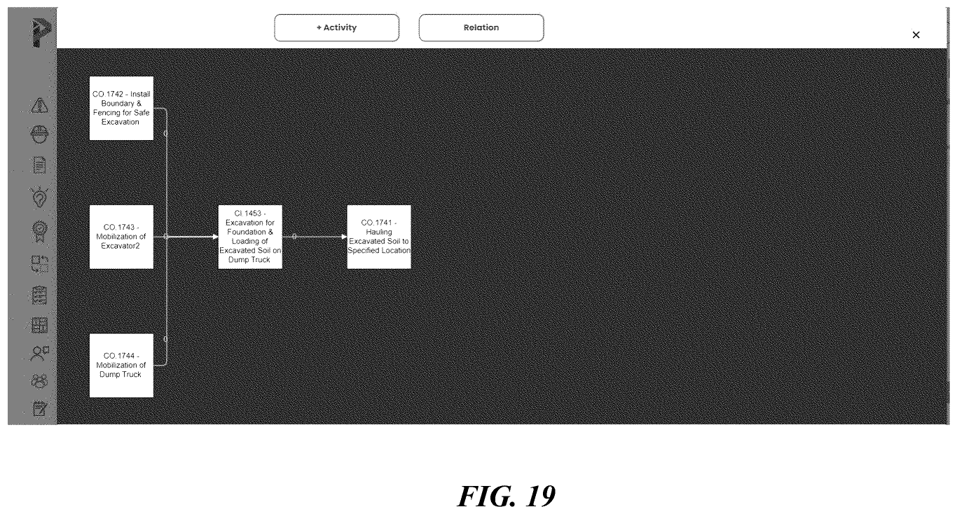

In some embodiments, the building block module 204 is configured to provide a digital representation (e.g., template) of one or more objects along with the various action steps and descriptions for how a respective object is built. For example, objects for the construction industry can contain all the data and information about the required materials, the specifications and quantities, the people and the necessary skill levels, the equipment and its capacity, the various risks involved during the construction process, etc. As shown in FIG. 19, a specific building block comprises a plurality of building activities that are required or unique for that building block.

In some embodiments, the building activity module 206 is configured to provide a virtual representation of a project activity, which can be copied one or more times with or without changing any of its attributes. The building activity module 206 contains all the data and information required for or specific to the materials, people and their skill requirements, equipment and its capacity, various risks involved during the performance of the activity, etc.

In some embodiments, the activity selector module 208 is configured to execute a process for selecting one or more activities for a building block. In such embodiments, the activities include, for example, the procurement of products and services for the project. In some embodiments, the activity selector module 208 is configured for execution every day or every shift so that the cost of project financing can be minimized. In some embodiments, the activity selector module 208 is configured to provide a method to reduce the project cost by saving money on the cost of project financing and/or the cost of handling and storing materials for the project.

In some embodiments, the resource allocator module 210 is configured to provide an accurate mapping of available resources with their respective skill sets and capabilities for the specific activity requirements. In this context, the term “resources” includes humans and equipment. In this context, the term “equipment” refers to tools, machines, robots, computer-driven equipment, etc.

In some embodiments, the progress update process module 212 is configured to provide an opportunity to capture the daily progress of each activity in any project so a stakeholder (e.g., employee, project manager) can know the real-time status of the project. In some embodiments, real-time change is implemented in this process by providing the Activity Team Lead (e.g., “Crew Lead”) and the Manager of the Activity with the ability to report the percent of progress earned every day, to edit the remaining duration required to complete the activity, and to store the edited, required remaining duration value.

In some embodiments, the process driver module 214 is configured to automate the process of activity selection, resource allocation to each of the project activities selected, updating the project Critical Path Method (CPM) schedule, and repeating the process as needed, including, e.g., daily.

In some embodiments, the success evaluator module 216 is configured to know the status of an activity, a group of activities, a project, a group of projects, an enterprise, or a group of enterprises by viewing or hearing a single color, grade, or a number based on the processing of one or more different dimensions of success in a way specified by the user.

In some embodiments, the heat map module 218 is configured to provide individual users (e.g., project managers and leaders) and project-oriented enterprises with a dynamic, real-time dashboard furnished with the required indicators, alarms, and levers relevant to the specific user so she can take appropriate actions.

In some embodiments, the resizing engine 222 is configured to facilitate the modification of data and information in a building block and a building activity. Accordingly, the resizing engine 222 is coupled to, among other components, the building block module 204, the building activity module 206, and the display module 202.

In some embodiments, the database engine 224 is configured to facilitate the storage, management, and retrieval of data to and from one or more storage mediums, such as the one or more internal databases 350, 355, 360, 365, 370, 375, 380, 385, 390, 395, 400, and 405. In some embodiments, the database engine 224 is coupled to an external storage system. In some embodiments, the database engine 224 is configured to apply changes to one or more databases. In some embodiments, the database engine 226 is configured as an in-process get, set, and update mechanism coupled to various sources, including, for example, volatile, in-process, or shared memory (e.g., RAM; application state). In some embodiments, the database engine 224 is configured with get, set, and update functions to call for an application programming interface (API) (e.g., a HTTP request) to interact with data stored on external web servers (e.g., cloud or private servers). In some embodiments, the database engine 224 is configured with get, set, and update functions to interact with data stored on attached non-volatile storage including, for example, a hard drive. In some embodiments, the database engine 224 is coupled to an external storage system including, for example, a USB-connected storage device. In some embodiments, the database engine 224 is configured to apply changes to one or more databases. In some embodiments, the database engine 224 comprises a search engine component for searching through thousands of data sources stored in different locations.

In some embodiments, the application engine 226 is configured to deploy the application program 200 to one or more servers, the servers being in the cloud or a private server.

In some embodiments, the communication module 228 is configured to allow one or more users of the system to communicate with one another. In some embodiments, the communication module 228 provides mechanisms for synchronizing the states between and/or across one or more users and/or devices. For example, the communication module 228 can allow a first user to see the interactions of a second user with the application program 200 from the virtual environment of the second user. In some embodiments, the communications module 228 is configured to associate communication identifiers (e.g., unique user ids) with a particular user or user device.

As shown in FIG. 3, a plurality of databases is included in the application program 200 and each database is in communication with the various components in the application program 200 via the database engine 224. In some embodiments, for example, the platform comprises a user database 350, a building block database 355, a building activity database 360, a resource database 365, a calendar database 370, a project database 375, a portfolio database 380, an enterprise database 385, a material database 390, a document database 395, an outputs and reports database 400, and an engine database 405.

In some embodiments, the user database 350 retrievably stores the data associated with a user of the system, including their e-mail address, pending and past projects, network access information (e.g., login, password), success metrics, communications within the system, and/or any other relevant information for implementing the project management system. In some embodiments, the user database 350 stores the data related to the building blocks, building block activities, and resources used by the user.

In some embodiments, the building block database 355 retrievably stores the data and information associated with a building block available for use in a process of the application program. In some embodiments, the building block database 355 retrievably stores the various activities, tasks, or steps required to build an object. In some embodiments, the building block database 355 retrievably stores all the data and information about the materials, their specifications and quantities, people and their skill requirements, equipment and its capacity, various risks involved during the construction process, etc. In some embodiments, the data and information retrievably stored in the building block database 355 is indexed by user. In some embodiments, the building block database 355 comprises a global building block library. In such embodiments, the building block database 355 comprises a search engine functionality that allows user to search the building blocks saved in the global building block library.

In some embodiments, the building block activity database 360 retrievably stores the data associated with each specific building block activity. In some embodiments, the materials, people and their skill requirements, equipment and its capacity, various risks involved during the performance of the activity are stored in the target database. In some embodiments, the data and information retrievably stored in the building block activity database 360 is indexed by user. In some embodiments, the building block activity database 360 comprises a global building block activity library. In such embodiments, the building block activity database 360 comprises a search engine functionality that allows user to search the building block activities saved in the global building block library.

In some embodiments, the resources database 365 includes the data and information for one or more resources (e.g., people, equipment) associated with a building block, a building block activity, a user, and/or a project. In some embodiments, the data and information retrievably stored in the resources database 365 is indexed by user. In some embodiments, the resources database 365 comprises a global resource library. In such embodiments, the resources database 365 comprises a search engine functionality that allows user to search the resources saved in the global resource library.

In some embodiments, the calendar database 370 retrievably stores the data related to scheduling projects and building block activities. In some embodiments, the calendar database 365 comprises an archived history of all projects and building block activities documented via the application program 200. As such, a user can retrieve information as to when the last time a particular project or building block activity was carried out, if ever.

In some embodiments, the project database 375 retrievably stores information and data related to one or more projects that are or have employed the application program 200.

In some embodiments, the portfolio database 380 retrievably stores information and data related to the portfolios (i.e., a group of projects) that are or have employed the application program 200.

In some embodiments, the enterprise database 385 retrievably stores information and data related to the enterprise systems that are or have been deployed using the application program 200.

In some embodiments, the material database 390 retrievably stores information and data related to the various materials utilized in each project that has or is employing the application program 200.

In some embodiments, the document database 395 retrievably stores information and data related to the various documents (e.g., contracts, invoices, orders, etc.) utilized in each project that has or is employing the application program 200.

In some embodiments, the outputs and reports database 400 retrievably stores information and data related to the various documents (e.g., contracts, invoices, orders, etc.) utilized in each project that has or is employing the application program 200.

In some embodiments, the engine database 405 retrievably stores information and data related to the deployment of the application program 200.

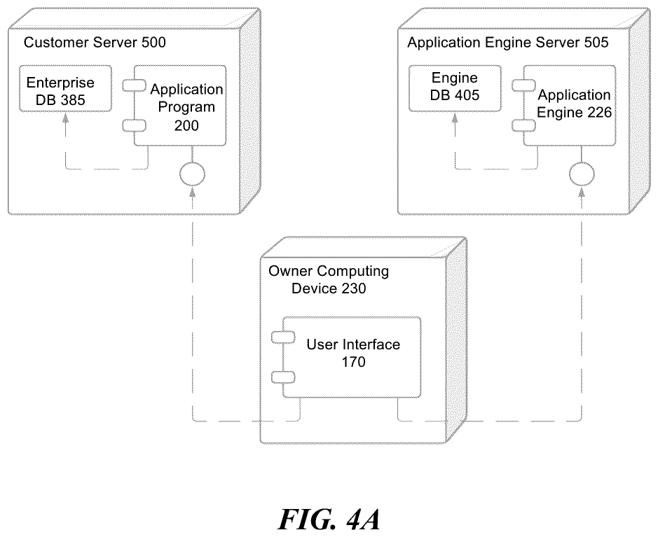

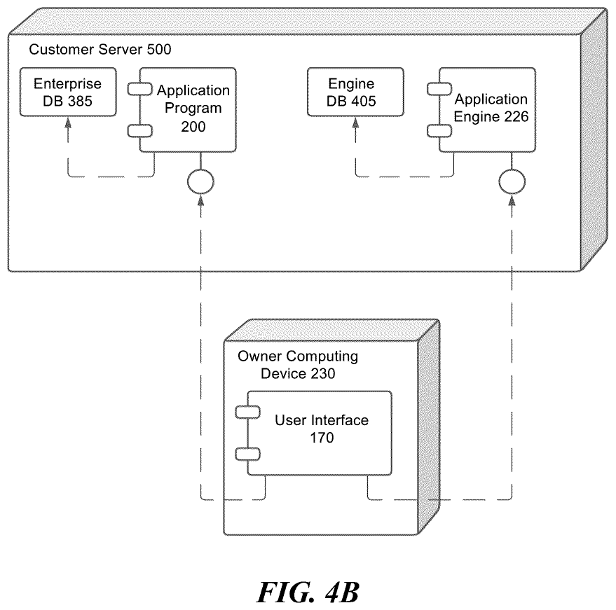

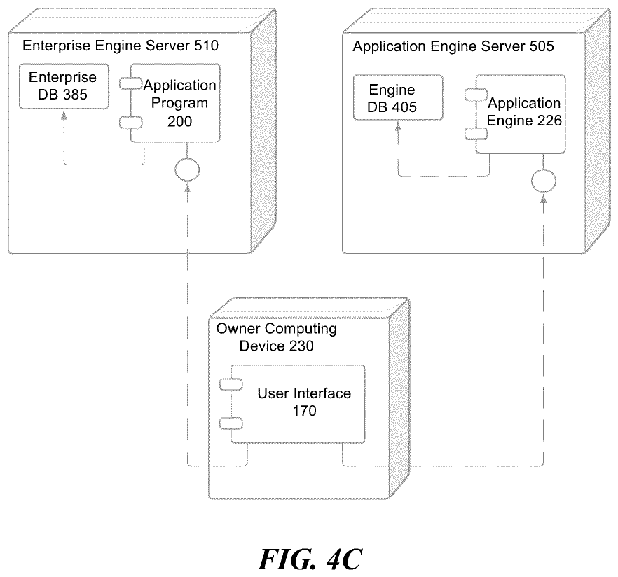

FIGS. 4A, 4B, and 4C illustrate embodiments for the deployment of servers involved with the application program 200. In some embodiments, as shown in FIG. 4A, the customer data is stored on the customer's server space 500, and the application engine 226 is hosted on the application server space 505. Both the customer server space 500 and the application server space 505 can be in the cloud or on their own servers. In some embodiments, as shown in FIG. 4B, the customer's server space 500 holds both the enterprise application and application engine. In some embodiments, as shown in FIG. 4C, the customer accesses the application 200 hosted on the enterprise engine server space 510.

### Resizing

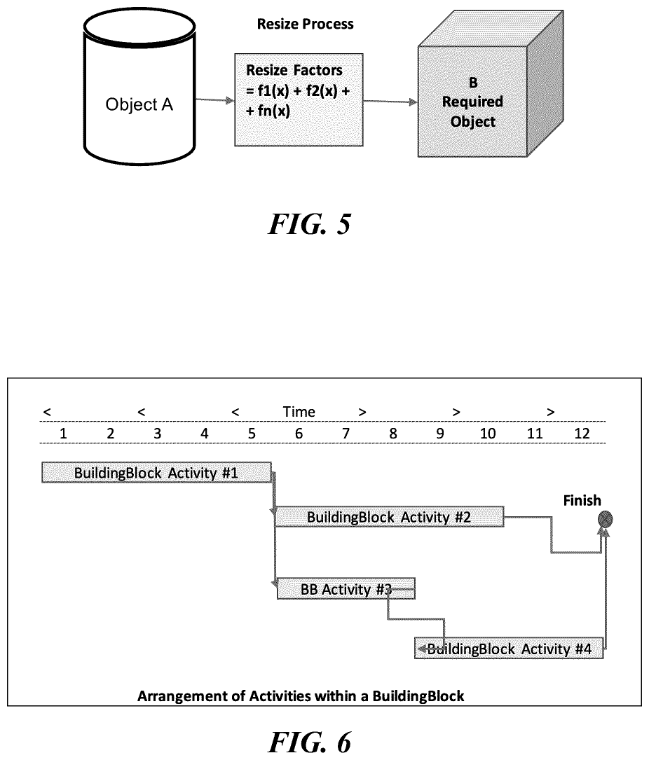

FIG. 5 illustrates the resizing mechanism carried out by the resizing engine 222. In this context, “resizable” means that an already existing Building Block or Building Block Activity can be modified to a different configuration of size, shape, material combination and the result would be a true representation of what the object should be.

In this context, “Resize Factor” means an aspect or aspects of a Building Block or Building Block Activity that can be resized. Examples include shape, size, material, color, etc., which are represented by f1(x), f2(x), . . . , fn(x) in FIG. 5.

In this context, “Resize Scale” is the operating function by which the Building Block or Building Block Activity is resized. For example, if the Resize Scale equals “Multiply by 5,” then the Building Block or Building Block Activity measure (e.g., size, weight) shall be multiplied by a factor of 5.

In some embodiments, it is not necessary or practical for one or more fields of data associated with a Building Block or Building Block Activity to be resized in the resizing process. In such embodiments, the fields of data that are not resizable will be identified as such.

In the resizing process shown in FIG. 5, for example, a user requires an object B, which is a rectangular prism of volume V_{b} and constructed from a material M_{b}. In this example, to obtain the object B, the user can rely on the Building Block A as a template, whereby the Object A has a cylindrical shape with a volume Vₐ that is constructed from a material Mₐ, and apply the Resize Factors f1(x), f2(x), . . . and fn(x) to convert Object A into Object B for use in a building block or building block activity.

### Building Blocks and Building Block Activities

FIG. 6 illustrates the arrangement of Building Block Activities within a Building Block. In some embodiments, the Activities can be arranged in serial or parallel depending on the attributes of the particular Building Block. Each Building Block provides the required information on what risks are involved and precautions to be taken to ensure the safety and quality of the people, equipment, materials, and the environment.

In some embodiments, the building blocks are content-rich. In this context, the term “content-rich” means the Building Block or Building Block Activity contains as much data as possible or required so the Building Block or Building Block Activity can be created successfully in a real-world project. In some embodiments, a content-rich and resizable Building Block is the digital representation of a construction object and contains the various action steps describing how the object is constructed. Information can be conveyed through any suitable means. For example, illustrations can be in audible, visual, or both forms using text, charts, images, audio, video, etc., that are retrievably stored in one or more digital file formats.

In some embodiments, the Building Block contains the various activities, tasks, or steps required to build the object. In such embodiments, the Building Block further contains all the data and information about the materials, their specifications and quantities, people and their skill requirements, equipment and its capacity, various risks involved during the construction process, etc. In some embodiments, the Building Blocks are created by assembling two or more Building Block Activities in a logical manner.

In some embodiments, a Building Block is a virtual representation of a physical object, and the representation can be copied one or more times such that one or more of its attributes can be independently modified at a later time. In some embodiments, the Building Block is as simple as a foundation or a piece of pipe, or as complex as a power plant, a refinery, or a high-rise building. For example, if a user wants to build a concrete foundation that is “x” cubic foot using a specific concrete material such as RCC M150, the user can select a Building Block of “y” cubic feet concrete foundation using the RCC M150 or another mix and then resize it to “x” cubic feet and change the mix to the new desired mix of the RCC M150. In such embodiments, the resizing engine 222 is configured to modify the Building Block with the necessary changes inputted by the user and the result will be a new set of estimates of time, cost, resources, materials, health and safety warnings and precautions, quality warnings and precautions, other risk warnings and precautions, the required documents to build this foundation, etc.

In some embodiments, the unique attributes of a Building Block are included at a shell level, which are added to the Building Block in addition to whatever are contained in the Activities. In some embodiments, the cost of the Building Block will be calculated based on the sum of the costs for each activity within the Building Block plus any unique cost of the shell-related attributes. In some embodiments, the time required for a Building Block will be calculated using a critical path method (CPM) algorithm. In some embodiments, for example, the health and safety, quality, other risks, etc., associated with each activity will be aggregated to the shell level of the Building Block. In such embodiments, any unique attributes will also be added.

The Building Blocks described herein are beneficial to project management for various reasons. For example, the Building Blocks are designed to cover all aspects of a project such as scope, cost, time, quality, safety, environment, and stakeholder satisfaction; such that when a Building Block or Building Block Activity is used for a project, it provides a complete template which can be modified (resized) to suit the specific situation. Such attributes allow the user to increase productivity and provide more accurate forecasts. The user can modify the results of a Building Block after a resizing to better suit a unique project.

Table 1 below shows the effect of Resizing. The Building Block is shown on the left-side column and the Resized object (the result) is shown on the right-side column.

TABLE 1
Changes Because of Resizing Building Block

| Building Block | | Resized Building Block |
|---|---|---|
| Building Block ID | Resize □ | Building Block ID |
| Building Block Name | | Building Block Name |
| Building Block | | Revised Building Block |
| Measure | | Measure |
| Building Block Attributes | | Building Block Attributes |
| Documents including | | Documents including |
| Drawings Required and | | Drawings Required and |
| Their Details | | Their Details |
| Quantity of Materials | | Revised Quantity of Materials |
| Required and Its Details | | Required and Its Details and |
| and Specifications | | Specifications |
| Quantity of Human Resources | | Revised Quantity of Human |
| Required, its Details, | | Resources Required, its |
| and Specifications | | Details and Specifications |
| Quantity of Equipment | | Revised Quantity of |
| Required and Its | | Equipment Required and |
| Details and Specifications | | Its Details and Specifications |
| Health & Safety Warnings | | Health & Safety Warnings |
| and Precautions | | and Precautions |
| Quality Warnings and | | Quality Warnings and |
| Precautions | | Precautions |
| Other Risk Warnings and | | Other Risk Warnings and |
| Precautions | | Precautions |
| Building Block Cost | | Revised Building Block Cost |
| Details | | Details |
| Building Block Estimate | | Revised Building Block |
| of Time Requirements | | Estimate of Time |
| | | Requirements |

There are numerous activities in any construction project. Simple examples include digging a hole in the soil or laying an electric cable from one point to another. In this context, the term “Activity” refers to the simplest form of a construction activity that cannot be broken down further, either due to practical, physical, or mechanical limitations, or because further breakdown would not provide any additional value.

In some embodiments, the Building Block Activities are retrieved from a library of Building Block Activities in the Building Block Activity Database 360 and assembled to create one or more larger and/or complex structures. In such embodiments, the process of assembling complex structures from simple Building Block Activities increases the efficiency, productivity, and accuracy of building project schedules and project control processes, and lowers the cost of construction project management.

The Building Block Activity accessed from the Building Block Activity Database 360 is complete with respect to all information that is required to successfully perform the activity. The process is consistent across a project or an enterprise which enables benchmarking and other similar studies.

In some embodiments, the Building Block Activity is content-rich. In some embodiments, the content-rich and resizable Building Block Activity is the digital representation of a construction project activity and illustrates how the activity should be performed. Such illustrations include audible or visual forms using text, charts, images, audio, video, etc.

In some embodiments, a Building Block Activity is a virtual representation of a physical project activity and can be copied one or more times with or without changing one or more of its attributes. In some embodiments, a Building Block Activity contains all the data and information about the materials, people and their skill requirements, equipment and its capacity, various risks involved during the performance of the activity, etc. In some embodiments, resizing a Building Block Activity provides the user with more accurate information. In some embodiments, the user can modify the results of a Building Block Activity after Resize to suit the project situation.

Table 2 shows the effect of Resizing. The Building Block Activity is shown on the left-side column and the Resized object (the result of resizing) is shown on the right-side column.

TABLE 2
Changes Because of Resizing Building Block-Activity

| Building Block-Activity | | Resized Building Block-Activity |
|---|---|---|
| Activity ID | Resize □ | Activity ID |
| Activity Name | | Activity Name |
| Activity Measure | | Revised Activity Measure |
| Activity Attributes | | Activity Attributes |
| Documents including | | Documents including |
| Drawings Required and | | Drawings Required and |
| Their Details | | Their Details |
| Materials Required and | | Revised Quantity and |
| Their Details | | Specifications of |
| | | Materials Required and |
| | | Their Details |
| Human Resources Required | | Revised Quantity and |
| and Their Details | | Specifications of |
| | | Human Resources Required |
| | | and Their Details |
| Equipment Required and Its | | Revised Quantity and |
| Details | | Specifications of |
| | | Equipment Required and |
| | | Its Details |
| Health & Safety Warnings | | Health & Safety Warnings |
| and Precautions | | and Precautions |
| Quality Warnings and | | Quality Warnings and |
| Precautions | | Precautions |
| Other Risk Warnings and | | Other Risk Warnings and |
| Precautions | | Precautions |
| Activity Cost Details | | Revised Activity Cost |
| | | Details |
| Activity Estimate of Time | | Revised Activity Estimate |
| Requirements | | of Time Requirements |

In some embodiments, the Building Block Activity is beneficial because it facilitates a reduction in the time, resources, and cost required to build project execution plans by using the Building Block Activities to assemble Building Blocks. For example, if a user wants to pour “x” cubic feet concrete RCC M150 into a void, the user can select a pre-built Building Block Activity of pouring “y” cubic feet concrete RCC M150 and then resize it to “x” cubic feet. It is also possible to change the concrete mix. In the example, within the Building Block Activity the necessary changes will occur, and the result will provide the user with a new set of estimates of time, cost, resources, materials, health and safety warnings and precautions, quality warnings and precautions, other risk warnings and precautions, the required documents to pour the concrete, etc.

### Daily Activity Selector

Activities in a project are generally scheduled using critical path method (CPM) in construction project management. CPM provides a list of dates for early start (ES), early finish, late start, and late finish, as well as the duration for each activity. It also provides the total float (TF) and free float for each activity. Early Start is the earliest date and time when a particular activity can be started. Late Start is the latest date and time when a particular activity can be started without delaying the project finish or the nearest constrained successor.

If the respective procurement of products and services are done on a Late Start basis the project would benefit in several ways. One benefit is a saving the money as interest in the cost of project financing. On large and complex multi-billion dollar projects, the saving can be as much as several millions of dollars. However, due to various uncertainties, an inability to control risks, the lack of tools to manage activities accurately, and an inability to calculate the savings in a Late Start schedule date approach, procurement managers tend to buy products and services as early as possible (based on Early Start dates), thus inadvertently increasing the project cost.

For F large projects in which hundreds of activities occur daily, it is difficult to accurately decide which activities must be selected for that day because the competition among the activities is driven by six factors (Early Start date, Total Float, Required Remaining Duration, Deliverable Priority, whether the Activity is Continuing or not, and whether the Activity can be broken or not). There is further difficulty because of the limited time the managers must select the activities. Existing reports often include “Today's Preliminary List of Activities” or something similar may be available (and in perhaps most cases no such list is available) just before a shift starts, and the managers must select the activities for execution on that day immediately for allocating work to employees. Otherwise, the start of activities will be delayed, which can lead to labor idling, wage losses, and project delay.

In various embodiments, a new process referred to as the Cost-Effective Daily Activity Selector process is provided for users to select activities, including procurement of products and services for projects, for execution every day or every shift so the cost of project financing can be minimized. The Cost-Effective Daily Activity Selector process is carried out by the Activity Selector Module 208.

In some embodiments, the first step of the process includes the selection of a list of activities from a CPM schedule generated by a scheduling software. In some embodiments, the Activities are selected based on the selection criteria described below. In some embodiments, the accuracy of the process is improved using components defined as “Deliverable” or “Breakable Activity.”

In this context, a “deliverable” is any unique and verifiable product, result, or capability to perform a service that is produced to complete a process, phase, or project. In some embodiments, the deliverables in the project are identified and listed with a Deliverable ID, Deliverable Name, and a Deliverable Priority Number. In such embodiments, the rule for the priority numbering is that the smaller the number the higher the priority. For example, the Deliverable with Priority Number 1 means that deliverable has the highest priority in the activity schedule of that project. In some embodiments, each activity in the CPM schedule is assigned a Deliverable ID. In this context, a “Breakable Activity” is an activity that can be broken before it is completed. An example is “Excavation in ordinary soil in normal situation.”

In this context, a “Non-breakable Activity” is one that cannot be or preferably be not stopped once the activity has started. Examples include mass concrete pouring and the welding of pipe joints having large a diameter and/or thickness.

In this context, “Required Remaining Duration (RRD)” is the number of days required to complete the activity as estimated by the Activity's Team Lead or Manager. In such embodiments, if the activity has not started, then the Required Remaining Duration (RRD)=Remaining Duration.

Table 3 shows the output from a CPM project schedule formatted as the input for the Daily Activity Selector.

TABLE 3
CPM Scheduler Output

| | | | | | | | | | |
|---|---|---|---|---|---|---|---|---|---|
| Activity | Activity | Continuing | ES | LS | TF | FF | Deliverable | RRD | OK to Break |
| ID | Name | Activity or | | | | | Priority | | the Activity? |
| | | Not (Y/N) | | | | | Number | | Yes/No |

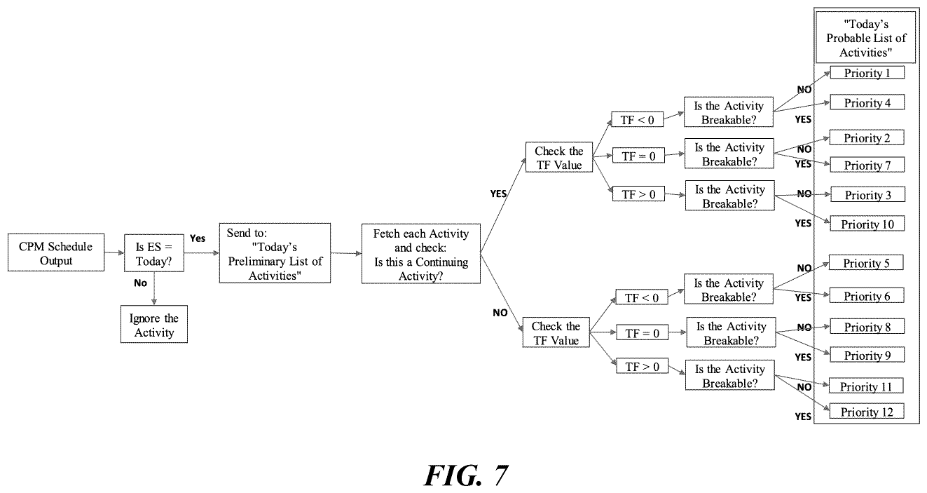

FIG. 7 is a flowchart providing an exemplary routine for the cost-effective daily Activity selector. The following rules are applied in the routine: (1) only the Activities that have ES=Today are selected and populated into a list “Today's Preliminary List of Activities.” (2) Activities from the list generated in (1) are grouped into “Continuing Activities” or “Not Continuing Activities.” The activities in each group generated in (2) are then grouped based on three grades of their Total Float (TF), namely TF<0; TF=0; and TF>0. (3) These six groups of activities are further grouped based on whether the Activity is Breakable or not. (4) The 12 groups of activities thus formed are listed under “Today's Probable List of Activities” and are prioritized as shown in FIG. 7. For example: Activities that are continuing, have TF<0, and are not breakable fall into “Today's Activity Priority 1.” (5) Activities in each Priority is further sorted based on the Deliverable Priority Number, Total Float, and Required Remaining Duration. Accordingly, the Effective Daily Activity Selector facilitates an accurately and speedily performed process.

### Resource Allocator

Project activity schedules that list activities to be taken up in a day or shift are generally based on an assumption that the required people, equipment, material, etc. are available for executing the planned work on the selected day. However, this is often not accurate because construction project plans are subject to sudden, unforeseen changes due to several factors like weather, natural calamities, absenteeism of employees due to seasonal illnesses, social unrest, holidays, breakdown of equipment, identification of defects in materials, etc. Generally, the resource allocation is executed manually; and managers are often influenced by approximations, prejudices, and biases; and their decisions may be inaccurate and at times lead to detrimental results. The decision-making process becomes more difficult when there is an imbalance between resource requirement and resource availability.

A computer-driven process for resource allocation to project activities based on sound logic and practicality will result in higher safety, productivity, quality, and equitability.

In this context, the term “resource” refers to humans, equipment, and the like. Equipment can refer to tools, machineries, robots, and computer-driven equipment. When allocating employees to activities their personal attributes can also be considered.

In various embodiments, the process described herein is configured to allocate employees and equipment in the most optimal way to project activities. The input to this process is the “Today's Probable List of Activities,” which is the output of the Cost-Effective Daily Activity Selector. The output contains a list of activities grouped in one of 12 groups of Today's Activity Priorities.

In some embodiments, employees are automatically checked-in using their mobile devices or proxy checked-in by their Managers or anyone authorized by the managers upon their arrival for work. When an employee is checked-in the system is instructed to search the work history of the employee to find what activity the employee was engaged in the previous day or shift. If there is a match, the system is instructed to determine whether the employee is required to continue the same activity. If the answer is affirmative, the employee will be assigned to that activity if the employee's role is available.

If the employee does not have a match or the employee is not required to do the previous day's activity, then the system is instructed to consider the Employee for allocation to every activity on the “Today's Probable List of Activities.”

Table 4 shows the various attributes of the Employee that need to be matched with the requirements of the Activity. Mandatory fields that are to be matched are shown in Table 4.

TABLE 4
Matching Employee Attributes to Activity Requirements for Resource Allocation

| | | Match | | | Match |
|---|---|---|---|---|---|
| Mandatory? | Employee Attribute | Weight | Mandatory? | Activity Attribute | Weight |
| Y | Employee Primary Role & | E1 | Y | Role N | A1 |
| | Skill Level | | | | |
| | Excellent/Good/ | | | | |
| | Satisfactory/Poor/Very | | | | |
| | Poor | | | | |
| | Employee Secondary Role | E2 | | | |
| | & Skill Level | | | | |
| | Excellent/Good/ | | | | |
| | Satisfactory/Poor/Very | | | | |
| | Poor | | | | |
| | Employee Tertiary Role & | E3 | | | |
| | Skill Level | | | | |
| | Excellent/Good/ | | | | |
| | Satisfactory/Poor/Very | | | | |
| | Poor | | | | |
| | Prior Experience in Similar | E4 | | | |
| | Activity: Yes/No | | | | |
| | Attendance | E5 | Y | Critical: Yes/No | A2 |
| | Excellent/Good/ | | | | |
| | Satisfactory/Poor/Very | | | | |
| | Poor | | | | |
| | | | Y | Driving: Yes/No | A3 |
| Y | Health & Safety Score | E6 | Y | Overall HSE | A4 |
| | Excellent/Good/ | | | Warning Severity: | |
| | Satisfactory/Poor/Very | | | 1 to 5 | |
| | Poor | | | | |
| Y | Quality Score | E7 | Y | Overall Quality | A5 |
| | Excellent/Good/ | | | Warning Severity: | |
| | Satisfactory/Poor/Very | | | 1 to 5 | |
| | Poor | | | | |
| Y | The maximum elevation the | E8 | Y | Elevation: ft or | A6 |
| | Employee is fit to work | | | meter | |
| Y | Employee Calendar | E9 | Y | Activity Calendar | A7 |
| Y | Willing to Work Overtime? | E10 | Y | Overtime Work? | A8 |
| | Yes/No | | | Yes/No | |
| | Productivity | E11 | | Productivity | A9 |
| | Excellent/Good/ | | | Required: | |
| | Satisfactory/Poor/Very | | | Very High/High/ | |
| | Poor | | | Standard/Low/ | |
| | | | | Very Low | |
| Y | Employee-Manager | E12 | | Manager Name | A10 |
| | Relationship | | | | |
| | Excellent/Good/ | | | | |
| | Satisfactory/Poor/Very | | | | |
| | Poor | | | | |
| | Employee-Crew Lead | E13 | | Crew Lead Name | A11 |
| | Relationship | | | | |
| | Excellent/Good/ | | | | |
| | Satisfactory/Poor/Very | | | | |
| | Poor | | | | |
| | Pay Rate ($/Hr) | E14 | | Is Cost Reduction | A12 |
| | | | | Required? Yes/No | |
| Y | Allergy to any material? | E15 | Y | Material N | A13 |

The value of above Match Weights are summed as below

| | | | |
|---|---|---|---|
| Employee Match Score | EM | Activity Match | AM |
| | | Score | |

In some embodiments, a user can define values of Match Weights of Employee attributes as well as the Match Weights of Activity attributes. In some embodiments, a complete and perfect match is not required because it may be unlikely for that to happen in every situation. In such embodiments, certain low threshold values will be established for the Employee and Activity. Each employee can specify a Minimum Employee-Activity Match Score ‘x’ below which the employee believes she/he will be unhappy.

In the example, Employee 1 will not work as a Laborer because for some reason, the manager can specify a Minimum Activity-Employee Match Score ‘y’ below which the manager believes the Activity cannot be executed successfully, which means if the employee's Match Weight for that attribute is less than the threshold, the employee is unfit for that activity.

For example: Smith is an ‘Excellent’ carpenter, which is his primary role. He can also work as a ‘Good’ mason, which is his secondary skill, and as a ‘Satisfactory’ laborer as his tertiary skill. Smith will derive an Employee-Activity Match Score of 5 when he works using his primary skills; 3 and 1, respectively, for his secondary and tertiary skills. Smith has established a Minimum Employee-Activity Match Score value of 3.

Activity 1 requires a ‘Good’ mason and Smith is a ‘Good’ mason. The Employee-Activity Match Score for the Employee Role is 3, and the Activity-Employee Match Score for Activity Role is 5. Similarly, other Employee Attributes and Activity Attributes also will be considered for the final Match Scores of Smith with respect to Activity 1.

Similar calculations are done for combinations of each employee against each activity, as shown in Table 5, and the values of an ‘Employee-Activity Match Score’ and ‘Activity-Employee Match Score’ are tabulated, as shown in Table 6 below.

TABLE 5

| Employee | Activity |
|---|---|
| ID/Name | ID/Name |
| E1 | A1 |
| E2 | A2 |
| E3 | A3 |
| . . . | . . . |
| En | An |
| | Ax |

TABLE 6

| Employee- | Employee- | Activity- |
|---|---|---|
| Activity | Activity | Employee |
| Combination | Match Score | Match Score |
| E1-A1 | S11 | M11 |
| E1-A2 | S12 | M12 |
| . . . | | . . . |
| E1-An | S1n | M1n |
| E1-Ax | S1x | M1x |
| . . . | | |
| En-A1 | Sn1 | Mn1 |
| En-A2 | Sn2 | Mn2 |
| . . . | | |
| En-An | Snn | Mnn |
| En-Ax | Snx | Mnx |

In some embodiments, the algorithm-driven resource allocation (Employee-Activity matchmaking) is configured with various limits. In some embodiments, a manager can override the decision. Also, in some embodiments, an attribute's matches are mandatory for an Employee or Activity as identified in Table 4 above.

### Examples of Mandatory Considerations

Employee's primary role, secondary role, or tertiary role with his/her corresponding skill levels shall be a match for any of the roles and its skill level listed in the Activity details to qualify for an allocation.

The Health, Safety, and Environment (HSE) Score of the employee shall be a proper match with the Activity's Overall HSE Warning Severity.

Quality Score of the employee shall be a proper match with the Activity's Overall Quality Warning Severity.

The employee shall be allocated work at or below the maximum elevation the employee is trained to work at.

Employee Calendar and Activity Calendar shall have a match.

If the Activity requires overtime work, whether the employee is willing for overtime work shall be checked.

Employee-Manager Relationship shall be satisfactory or better.

Employee-Crew Lead Relationship shall be satisfactory or better.

If the Employee has any allergies to certain materials, the employee shall not be assigned to work that involves those materials.

In some embodiments, a user can define the mandatory fields. In such embodiments, certain attributes are not significant in certain industries. For example, safety is critical in construction projects but less relevant in the software or banking industries.

In some embodiments, the allocation of equipment for Activities is also done using similar logic and flow.

In some embodiments, the process is semi-automatic because a user can manually change the resource allocation if the Manager is not satisfied with the resource allocation provided by the computer application. In some embodiments, the process is dynamic and real-time because the resource allocation is done based on the resources available for a specific day and for a specific shift. In some embodiments, the process is dynamic because it adjusts to changes from the resource allocation of the previous day or shift.

### Daily Activity Progress Update Process

Some construction project activities are scheduled using Critical Path Method (CPM). In such a method, when work is performed the CPM schedule is updated periodically with the activity progress and status update so the CPM schedule can be recalculated to avail the new status of the project, to detail when the project will be completed, and at what cost. Schedules are updated by changing the percent (%) of progress earned, by changing the remaining duration, or a combination of both. Some existing project schedules are updated more often by dedicated software operators rather than by employees who perform the work. Similarly, there are no checks and balances in existing processes, which can lead to data transmission errors and willful data manipulations.

In various embodiments herein, the progress update data entries are made by the employee or the leader of the team if the activity is performed by a team. It is further reviewed by the concerned manager who can approve, edit, or reject the progress update data entry. Accordingly, the Daily Progress Update process is more accurate than the existing processes.

In some embodiments, the Daily Activity Progress Update Process detailed here provides an opportunity to capture the daily progress of each activity in any project so that any stakeholder, from employee to Project Owner, can know the real-time status of the project. In some embodiments, a real-time change is implemented in this process by providing the Activity Team Lead (called Crew Lead) and the Manager of the Activity the ability to report the precent of progress earned every day and to edit the remaining duration required to complete the activity, and then store this edited remaining duration value as Required Remaining Duration. One or more changes occur because of these changes, such as (Cost) Estimate at Completion and Estimate of Project Completion Date. Accordingly, the results obtained through this method are more accurate than obtained through existing methods.

In various embodiments, a user can forecast the time required to complete the activity, called the ‘Required Remaining Duration’ in this application. By contrast, existing software requires a user to change the remaining duration to make an approximate forecast.

In this context, the term “Remaining Duration” is the result of an arithmetical operation:

Remaining Duration=Budgeted Duration−Expended Duration, whereas Required Remaining Duration is a subjective estimation done by the leader of the team that performs the activity, or the leader's supervisor or manager. Remaining Duration is a good indicator as to whether the work has progressed as planned and will progress further as planned.

Required Remaining Duration is not the same as Estimate to Complete (ETC). Estimate to Complete is a forecast based on the past performance. The past is a good indicator of the future in some cases but not necessarily always. However, the team leader, supervisor, or manager who makes an estimate of the Required Remaining Duration may make the forecast considering the past as well as the opportunities and threats in the future of the activity, including the will and determination of the employee or the team. This method will be more accurate than the ETC (which is derived through mathematical calculation only) because Required Remaining Duration is based on the objective and subjective considerations of the Activity by the team who executes the Activity.

A second difference is that the user can change the quantities of the Activity measure for any material used in the Activity. For example: a foundation of 1 m³ is being constructed that requires the following quantities of items by weight:
cement=364.5 kg.
aggregate (sand)=546.75 kg.
coarse aggregate=1,093.5 kg.

In some embodiments, if a user wants to change the volume of concrete from 1 m³ to a different volume it is possible and the subsequent calculations of time, material, and cost will occur immediately. Or, if the user wants to change the quantity of cement from 364.5 to 374.5 because 10.0 kg of cement got lost or damaged, e.g., via handling, that also will be possible in this process.

Table 7 shows the differences between existing methods and the embodiments herein using the method for updating the daily activity progress.

TABLE 7
Comparison of Daily Activity Progress Update Process

| Existing | Embodiments in this Application |
|---|---|
| Activity ID | Activity ID |
| Activity Name | Activity Name |
| Remaining Activity | Remaining Activity Measure and |
| Measure | Required Remaining Activity Measure |
| Remaining Material | Remaining Material Measure and |
| Measure | Required Remaining Material Measure |
| Remaining Activity | Remaining Activity Duration and |
| Duration | Required Remaining Activity Duration |
| Formula for Estimate at | Formula for Estimate at Completion |
| Completion (EAC) | (EAC) |
| EAC = Expended + | EAC = Expended + Remaining OR |
| Remaining | EAC_{UC} = Expended + Required |
| | Remaining, where _{UC} stands for Un- |
| | Conventional |
| | These formulas can be used for |
| | calculation of Duration, Labor-Hour, |
| | Labor Cost, Equipment-Hour, Equipment |
| | Cost, Material Quantity, Material Cost, |
| | Other Costs, and Total Cost of Activities |

### Process Driver

Existing processes of managing construction projects that include the engineering and design of a structure or facility, the procurement of materials, products, and services, and the constructing the structure or the facility at the location, generally require manual input. As provided herein, by contrast, the automation of the construction management process by the Construction Management Driver leads to increased productivity, better quality, reduced cost of operations, and improved health and safety of employees.

Even within each of the phases, such as engineering and design, procurement, or construction, there are numerous large and small activities that need to be performed by humans or equipment so the intended structure or facility can be successfully completed. Some of the activities are small and take only a few minutes to complete, and some are large and take as long as several days to complete. Some of the activities may require fewer resources and materials while others require large resources and materials. The cost and timely completion of the project are dependent on the selection of activities daily for execution and proper allocation of resources against the selected activities. In various embodiments, the Process Driver is configured, for example, to automate the process of activity selection, resource allocation to each of the project activities selected, updating the project CPM schedule, and repeating the process daily.

The Construction Management Driver has four sub-processes:
(i) Selection of activities for execution on that day or shift. In some embodiments, the Daily Activity Selector will be used for that purpose.
(ii) Allocation of resources (people and equipment) to the selected activities (i) above in the most optimal way possible. In some embodiments, the Resource Allocator will be used for that purpose.
(iii) Daily progress update of activities in which each of the selected activities are updated by the authorized persons about the progress and status of the activity. In some embodiments, the Daily Activity Progress Update Process will be used for that purpose.
(iv) CPM calculations based on the progress update.

In various embodiments, the Construction Management Driver process starts with the Daily Activity Selector, which performs the Daily Activity Selection. On completion of the Daily Activity Selection, the Process Driver performs the resource allocation using the Resource Allocator. Once the resources are allocated, the resources can start performing their allocated work and report the progress. The progress update is performed using the Daily Activity Progress Update Process. The CPM schedule is calculated again based on the new daily activity progress update. The new schedule output serves as the input for the next day's (or shift's) Daily Activity Selector and the process continues until the project is completed or the process is terminated.

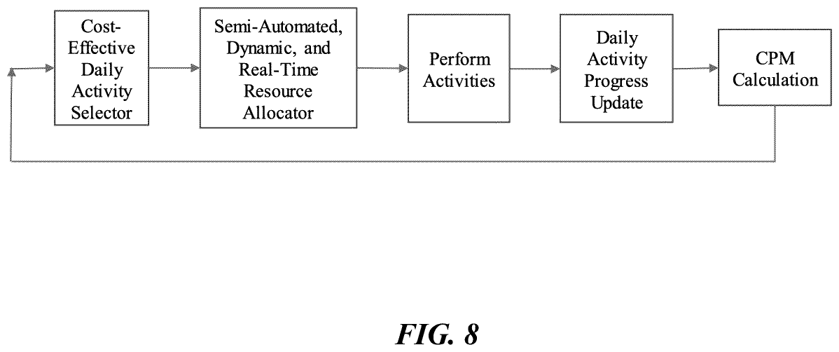

The flowchart in FIG. 8 shows a high-level summary of the process. In some embodiments, the process comprises alerts and warnings to prompt the participants to take appropriate actions timely and correctly. In some embodiments, the Process Driver uses a CPM-based activity schedule of the construction project as its main input.

### Multi-Dimensional Project Success Evaluator

There remains a need for a system that provides users with the status of an activity, a group of activities, a project, a group of projects, an enterprise, or a group of enterprises, by viewing or hearing a single color, grade, or a number based on the processing of various factors or dimensions of success in a way specified by the user.

In various embodiments, the success evaluator module 216 provides a model for measuring project success and distilling and displaying the determination using a color, grade, or a number so a user can know the project status or project outcome. The knowledge of the project outcome, whether the project is or was successful or not, can prompt the user to analyze the causes for its success or failure.

In some embodiments, the success evaluator module 216 operates in the context of the following definitions:
(i) The Activity Success Criteria is a set of conditions that define whether an activity is successful or not, and its various levels of success and failure. An example is provided in Table 8.

TABLE 8
Example of Activity Success Criteria

| Color | Grade | Number | Activity Performance Score* |
|---|---|---|---|
| Green | Excellent | 5 | Average is higher than 4 and subject |
| | | | to not having anything less than 4 |
| Blue | Good | 4 | Average is higher than 3 and subject |
| | | | to not having anything less than 3 |
| Colorless | Satisfactory | 3 | Average 3 or more and subject to not |
| | | | having anything less than 3 for any |
| | | | Critical Dimension; may have 2 and |
| | | | above for non-critical |
| Yellow | Poor | 2 | Average 2 or more and subject to not |
| | | | having anything less than 3 for any |
| | | | Critical Dimension; may have any for |
| | | | non-critical |
| Red | Very Poor | 1 | Anything which does not fall into |
| | | | the above categories |

Activity Performance Score* is defined in a paragraph below.
(ii) The Activity Dimension is a measurable aspect of an activity that is important for managing the activity and identified as a project management performance metric by the user. An Example is provided in Table 9, Column 1. Activity Dimensions may be classified as critical or non-critical based on each activity. For example, health and safety may be critical in activities performed at high elevations from ground, whereas quality may be non-critical in excavation of a small quantity of soil at ground level.

TABLE 9
Activity Dimension

| Activity Dimension | Weightage | Critical |
|---|---|---|
| Scope | w₁ | Y/N |
| Health & Safety | w₂ | Y/N |
| Quality | w₃ | Y/N |
| Schedule | w₄ | Y/N |
| Cost | w₅ | Y/N |
| Stakeholder Satisfaction | w₆ | Y/N |
| Environment | w₇ | Y/N |
| Total | 1.0 | |

In some embodiments, the Activity Dimension Weightage is the value of importance assigned to an Activity Dimension for comparison with other Activity Dimensions. The sum of all the Weightages shall equal 1.0. An Example is shown in Table 9, Column 2. Since the importance of each of these dimensions may be different for different activities, the Project Manager can add new dimensions or delete current dimensions or assign different weightages to each as he/she thinks fit. Each of the Activity Dimensions will have only one value (weightage). There will be a number of activities in a project. The value of Activity Dimension X Weightage of Activity A may differ from the value of Activity Dimension X Weightage of Activity B.
(iii) The Activity Dimension Rating is a color, grade, or a number awarded by an Evaluator (defined later) based on the performance of the Activity Dimension. For example: FIG. 11 shows the Evaluator using a dropdown numerical scale to select and award a rating for the Environment dimension.

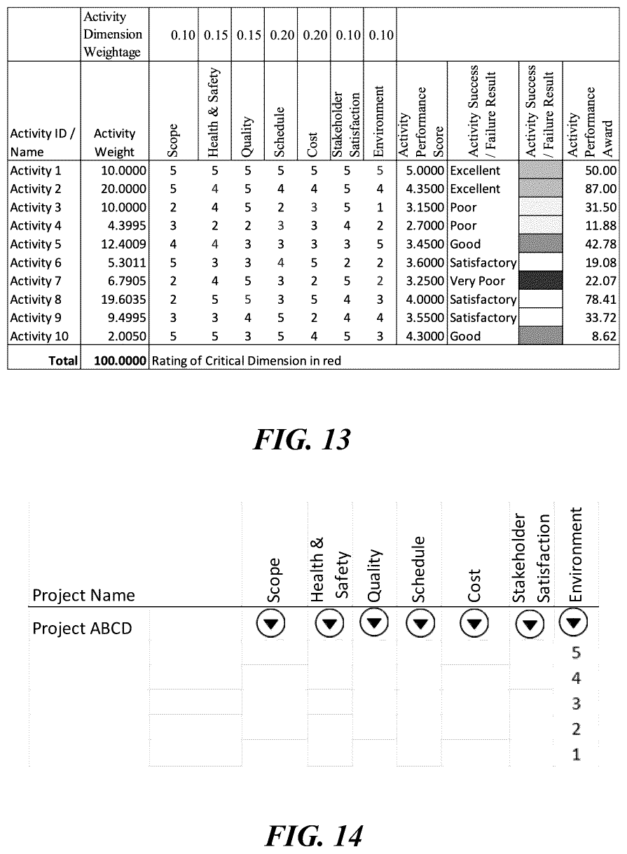

The Activity Dimension, Activity Dimension Weightage, Activity Dimension Rating, Activity Dimension Score, and Activity Performance Score are illustrated in FIG. 12.
(iv) The Activity Dimension Score is equal to the product of the Activity Dimension Rating multiplied by the Activity Dimension Weight.
(v) The Activity Performance Score is based on the performances of all the Activity Dimensions. This is equal to the sum (or a different function) of all the Activity Dimension Scores.
(vi) The Activity Weightage is the value of importance assigned to an Activity for comparison with other Activities in the same project. The sum of all the Activity Weightages shall be equal to 100.
(vii) The Activity Performance Award is the value contributed by an activity to the project or a group of activities. This is equal to Activity Performance Score multiplied by the Activity Weightage. For example, see FIG. 13.
(viii) The Project Success Criteria is a set of conditions that define whether a Project is successful or not, as well as its various levels of success and failure. An example is provided in Table 10.

TABLE 10
Project Success Criteria

| Color | Grade | Number | Project Performance Score |
|---|---|---|---|
| Green | Excellent | 5 | Average is higher than 4 and subject |
| | | | to not having anything less than 4 |
| Blue | Good | 4 | Average is higher than 3 and subject |
| | | | to not having anything less than 3 |
| Colorless | Satisfactory | 3 | Average 3 or more and subject to not |
| | | | having anything less than 3 for any |
| | | | Critical Dimension; may have 2 and |
| | | | above for non-critical |
| Yellow | Poor | 2 | Average 2 or more and subject to not |
| | | | having anything less than 3 for any |
| | | | Critical Dimension; may have any for |
| | | | non-critical |
| Red | Very Poor | 1 | Anything which does not fall into the |
| | | | above categories |

(ix) The Project Dimension is a measurable aspect of a project that is important for managing the project and identified as a project management performance metric by the user. Project Dimensions may be classified as Critical or Non-Critical based on each project. For example: Health and Safety may be Critical in oil and gas projects. Cost may be non-critical in a turnaround project whereas Schedule may be critical. An example of Project Dimensions is shown in Table 11, Column 1.

TABLE 11
Project Dimensions

| Project Dimension | Weightage | Critical |
|---|---|---|
| Scope | x₁ | Y/N |
| Health & Safety | x₂ | Y/N |
| Quality | x₃ | Y/N |
| Schedule | x₄ | Y/N |
| Cost | x₅ | Y/N |
| Stakeholder Satisfaction | x₆ | Y/N |
| Environment | x₇ | Y/N |
| Total | 1.0 | |

(x) The Project Dimension Weightage is the value of importance assigned to a Project Dimension for comparison with other Project Dimensions. The sum of all the Weightages shall be equal to 1.0. An example is shown in Table 11, Column 2. Since the importance of each of the dimensions may be different for different projects, a Project Manager can add new dimensions or delete current dimensions or assign different weightages to each of these as he/she thinks fit. Each of the Project Dimensions will have only one value (weightage) each. There will be one or more projects in a group, portfolio, or enterprise. The value of Project Dimension X Weightage of Project A may differ from the value of Project Dimension X Weightage of Project B.
(xi) The Project Dimension Rating is a color, grade, or a number awarded by an Evaluator based on the performance of the Project Dimension. For example, see FIG. 14. In the example, the Evaluator uses a dropdown numerical scale to select and award a rating for the Environment dimension. A Project Dimension Rating may also be calculated from the project activities.

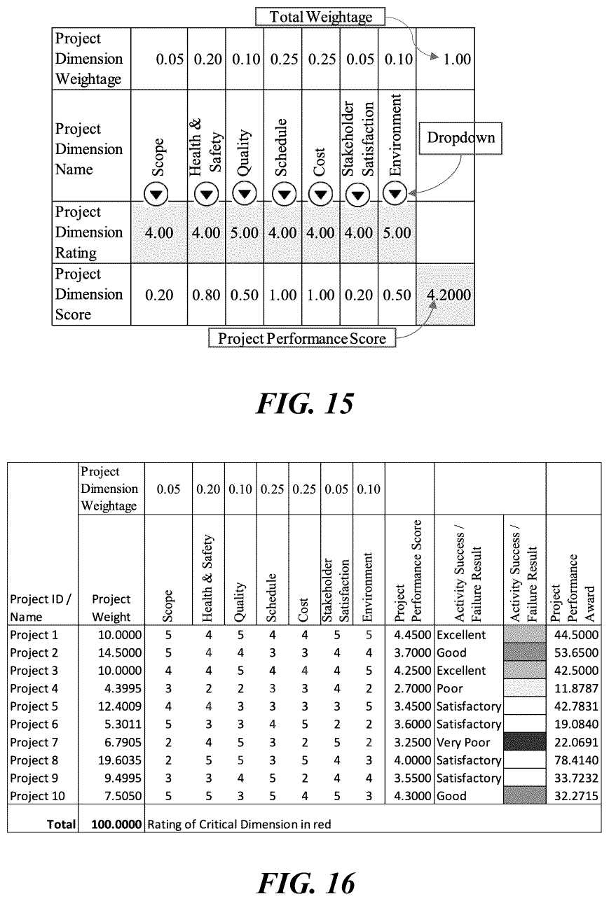

The Project Dimension, Project Dimension Weightage, Project Dimension Rating, Project Dimension Score, and Project Performance Score are illustrated in FIG. 15.
(xii) The Project Dimension Score is equal to the product of the Project Dimension Rating multiplied by the Project Dimension Weight.
(xiii) The Project Performance Score is on the performances of all the Project Dimensions. This is equal to the sum (or a different function) of all the Project Dimension Scores.
(ixv) The Project Weightage is the value of importance assigned to a Project for comparison with other Projects. The sum of all the Project Weightages shall be equal to 100.
(xv) The Project Performance Award is the value contributed by a Project to the enterprise or a group of projects. This is equal to Project Performance Score multiplied by the Project Weightage, as shown in FIG. 16.

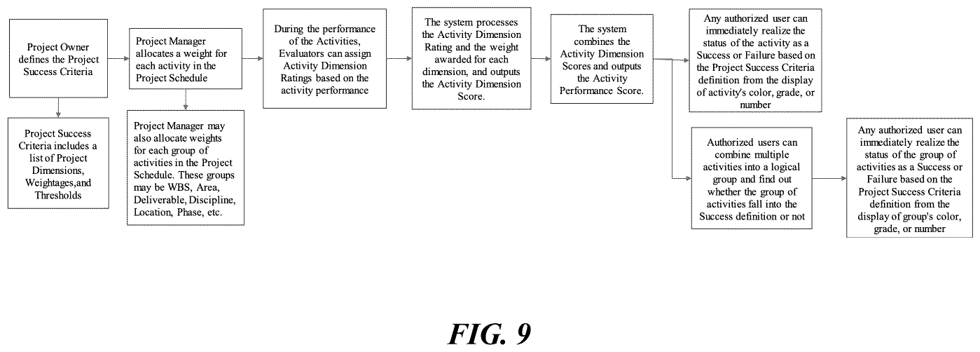

The process flow is as shown in the Flowchart in FIG. 9.

Step 1: The Project Success Owner defines the Project Success Criteria and lists out the Project Dimensions. The Project Success Owner may be the organization or a person who determines to implement the Multi-Dimensional Project Success Evaluator on a project or at an enterprise and who has the authority to do so. For the purposes of the following steps, the decision maker for the day to day management will be delegated to the Project Manager, who implements this process at the Project.

Step 2: The Project Manager authorizes one or more persons to review the performance of activities in the project from each dimensional perspective. The inputs to each of the dimensions can be obtained from both quantitative and qualitative measurements. For example, Scope, Schedule and Cost performance data can be collected from quantitative metrics. Health and Safety and Quality can be measured using both quantitative and qualitative measurements. Stakeholder Satisfaction and Environment performance measurements may be done using mostly qualitative data. Qualitative data will be collected through online surveys at activity level or group (of activities) level.

In some embodiments, a reviewer can use any of the scales listed in Table 12 (color, grade, or a number) to provide the feedback on the activity performance where qualitative method is used. In such embodiments, each of those options must have a numerical value (Numerical Value Examples 1 and 2) so their answers can be converted to a number for further calculations. FIG. 11, for example, shows the Activity Dimension Rating Numerical Value for Example 1, for inputting the Activity Dimension Rating.

TABLE 12
Activity Performance Criteria

| | | Numerical | Numerical | |
|---|---|---|---|---|
| | | Value | Value | |
| Color | Grade | Example 1 | Example 2 | Alphabet |
| Green | Excellent | 5 | 5 | A |
| Light Green | Good | 4 | 3 | B |
| Colorless | Satisfactory | 3 | 0 | D |
| Orange | Poor | 2 | −3 | E |
| Red | Extremely | 1 | −5 | F |
| | Poor | | | |

Step 3: On completion of availing the inputs from qualitative, quantitative, or a combination of both means, the system automatically calculates an “Activity Dimension Score.”

Activity Dimension Score=(Activity Dimension Rating 1 multiplied by the Activity Dimension Weight 1)+(Activity Dimension Rating 2 multiplied by the Activity Dimension Weight 2)+ . . . (Activity Dimension Rating N multiplied by the Activity Dimension Weight N)], wherein, for example, Dimension 1 may be ‘Scope’, Dimension 2 may be ‘Health and Safety,’ . . . etc.

Step 4: Upon completion of availing the inputs from qualitative, quantitative, or a combination of both means, the system automatically calculates an “Activity Performance Score.”

Activity Performance Score=Sum (or another function) of all the Activity Dimension Scores.

In some embodiments, a user (e.g., project manager) may have established certain threshold values for one or more of the dimensions below which no activity shall qualify for that classification, and the impact of the threshold values also must be considered. For example, according to the Activity Success Criteria in Table 8, an activity will be deemed Satisfactory only if the average Activity Performance Score is 3 or more and subject to not having anything less than 3 for any Critical Dimension.

The Activity Performance Score is an accurate indication of the activity's performance. The Score may be converted to a color, grade, or a number as shown in Table 12.

Step 5: After all the individual Activity Performance Scores are calculated, it is possible to determine the Group Performance Score. Every project has one or more activities to be performed. These activities can be grouped based on attributes or other criteria. Work breakdown structure (WBS), Discipline, Phase, Period of work, work location, process, system, deliverable, etc. can be considered as groups. A project also can be considered as a Group, and a Group of projects can be formed into a Portfolio. To display the status of a group of activities as a color, grade, or a number, the Activity Performance Score of all the activities must be codified in a way as specified in the Project Success Criteria as in Table 10.

In some embodiments, the Dimension Rating measurements are calculated at Activity level, when possible. The measurements will be aggregated to Group level. If the measurement cannot be done at Activity level, then it will be done at Group level; if the measurement cannot be done at Group level, then it will be done at Project level. Summarization or codification of the individual Activity Performance Scores to a Group Performance Score also must be well defined. In some embodiments, an arithmetic average may work in several instances, as shown in Tables 8 and 10.

### Real-Time Dynamic Heat Map Dashboard

One of skill in the art would appreciate that a lack of real-time visibility with respect to the activities in a project can be a reason for project failure. Without an awareness of any issues arising in a project, managers lose the opportunity to take necessary actions to mitigate the issues.

In some embodiments, the real-time dynamic heat map module 218 provides information to a user at their respective level of the project. For example, the project manager needs information and data at the project-level and the corporate executives need enterprise-level information and data. The real-time dynamic heat map module 218 provides such data and information so managers and executives can take timely action to address issues.

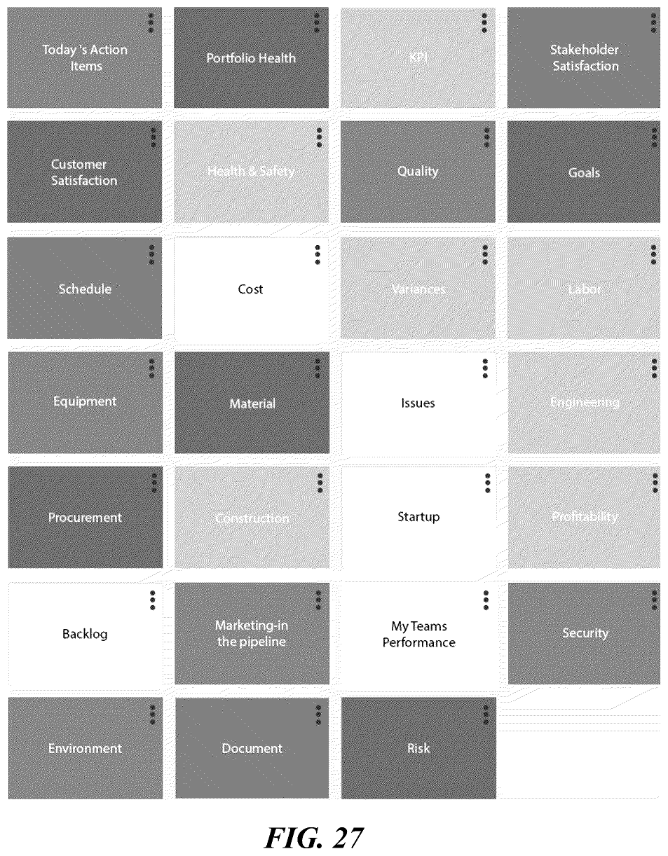

FIG. 27 discloses a heat map dashboard according to embodiments described herein. In some embodiments, the heat map module 218 provides real-time information because the data is real-time or as close to real-time as possible. In some embodiments, the heat map module 218 provides dynamic information because the dashboard in FIG. 27 because the system is configured to update the data as it is acquired. In some embodiments, the dashboard is furnished with indicators, alarms, and levers that a user can take interpret and respond to.

In various embodiments, the dashboard in FIG. 27 comprises one or more widgets, each of which represents a specific dimension of an activity or a group of activities in a project, a group of projects, an enterprise, or a portfolio of enterprises. In some embodiments, each widget comprises a name and a color that represent the status of the activity or the group of activities in the project, the group of projects, or the enterprise. In some embodiments, each widget comprises the name of the activity or the group of activities in the project, the group of projects, the enterprise, or the portfolio that it represents.

In various embodiments, the dashboard in FIG. 27 provides a user action profile, wherein the user can rely on the information provided by dashboard as a recommendation to take an action. In some embodiments, the widgets on the dashboard comprise: Today's Action Items, Portfolio Health, KPI, Stakeholder Satisfaction, Customer Satisfaction, Health and Safety, Quality, Goals, Schedule, Cost, Scope, Variances, Labor, Equipment, Material, Issues, Engineering, Procurement, Construction, Startup, Profitability, Backlog, Marketing, In the Pipeline, My Team's Performance, Security, Environment, Document, Risk, etc.

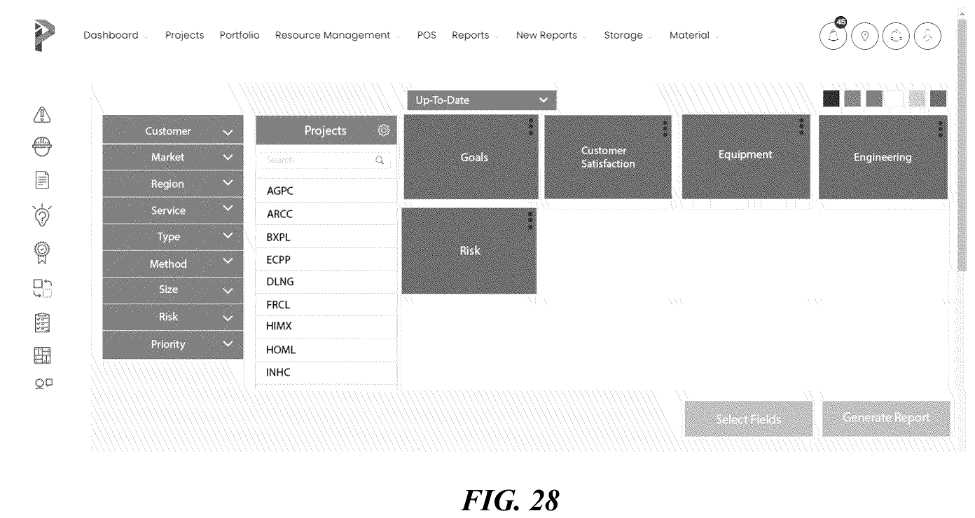

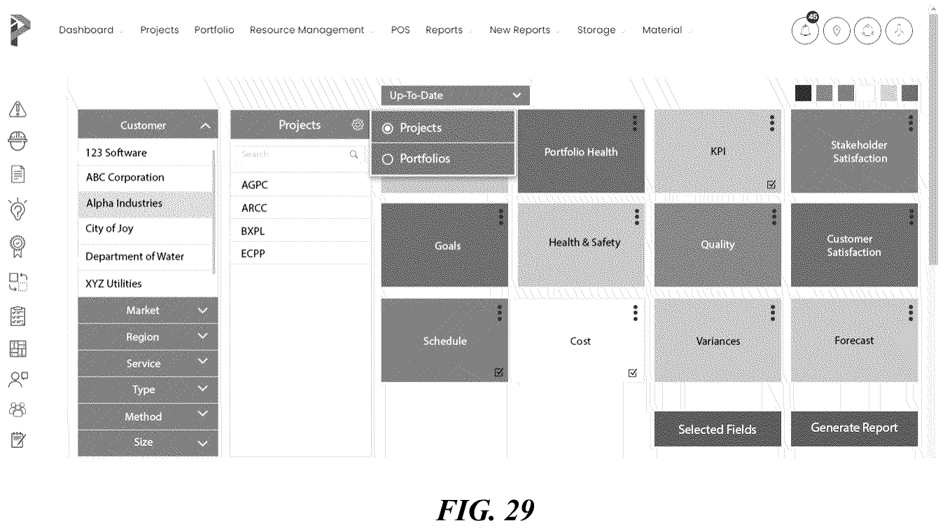

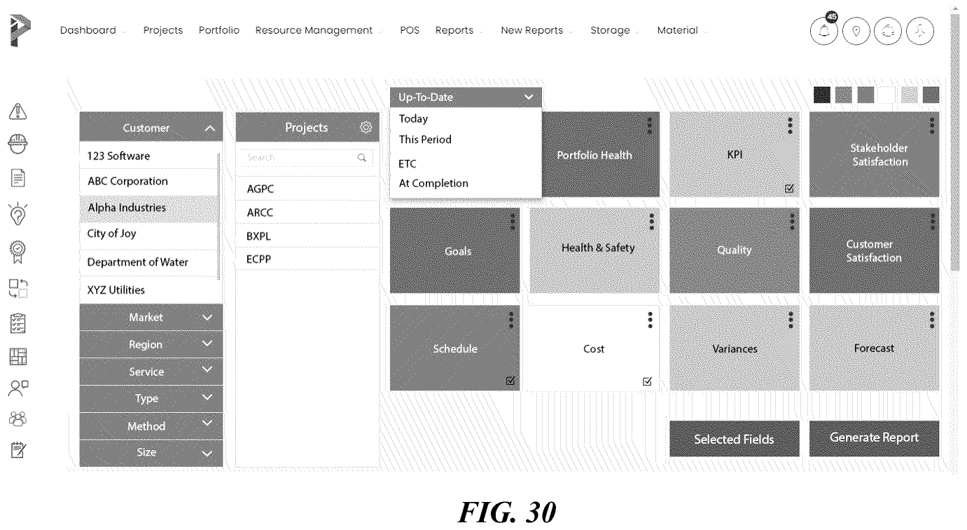

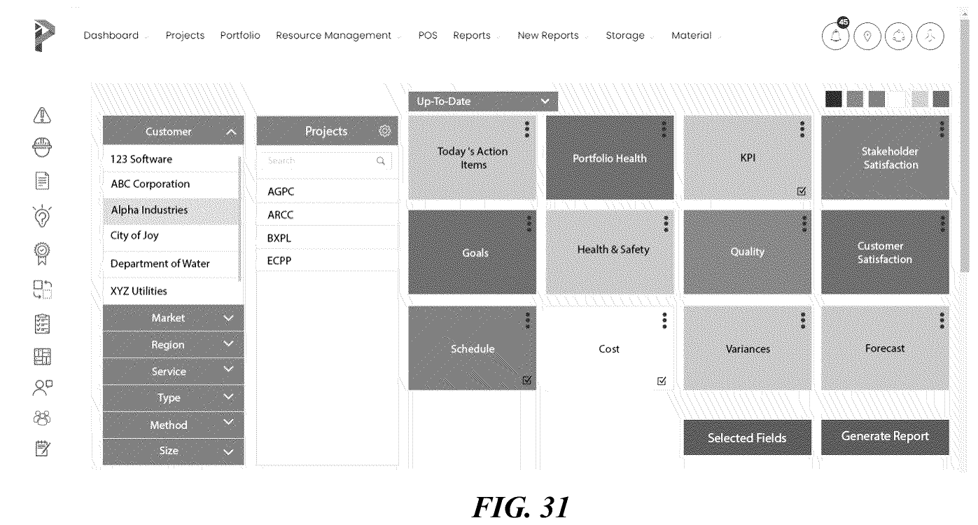

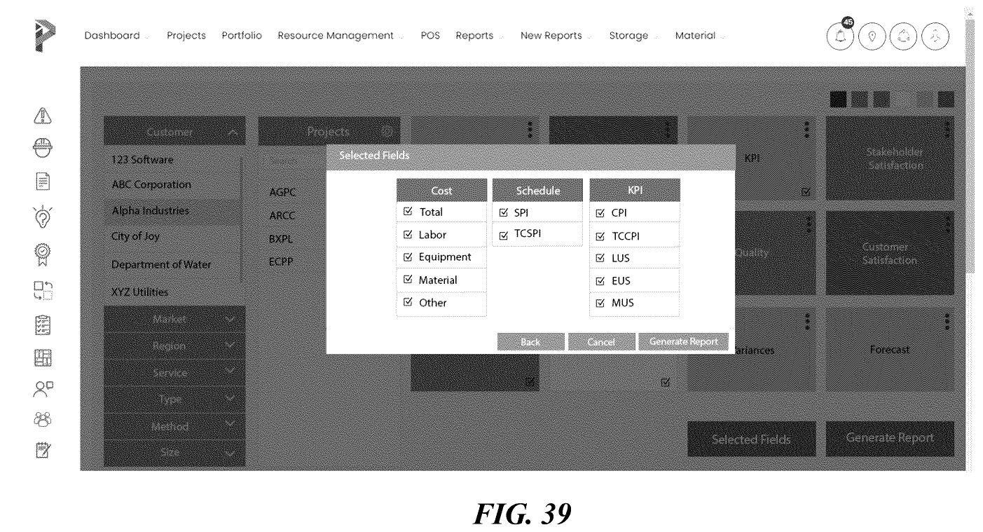

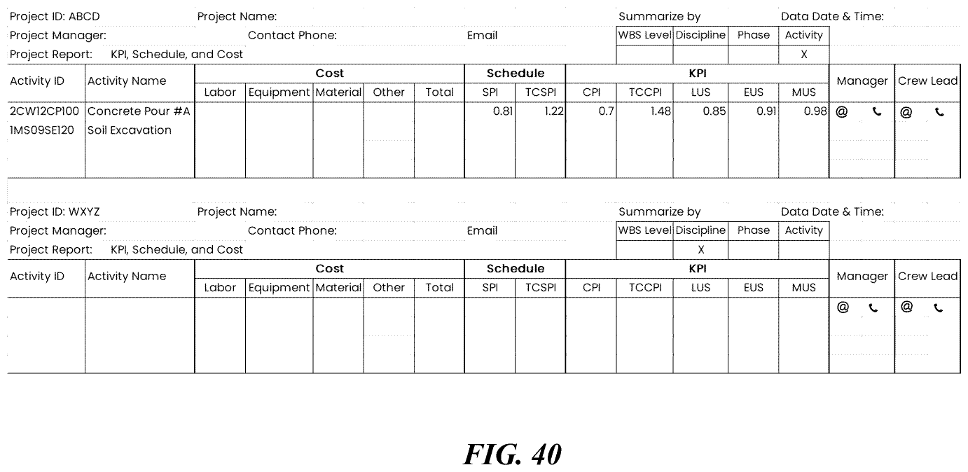

In some embodiments, the user can customize the dashboard output (i.e., what is displayed). For example, the user can: add, delete, or change the arrangement of the widgets; select data by customer, market, region (geography), service provided, type of project, method of contracting or project delivery, size of project, risk rating of the project, and project priority; select based on performance (by color) (FIG. 28); by projects or portfolios (FIG. 29); change the timing of the data: Today, Up-to-date, This Period, Estimate to Complete (ETC), and At Completion (FIG. 30); select elements of any widget (FIGS. 31-38); apply multiple criteria concurrently (FIG. 39); and generate reports (FIG. 40). All the information on the dashboard is driven by data at activity level. By navigating through the dashboard and digging deep into the database the user will be able to identify status of any activity and/or resource and analyze why the situation is good or bad so appropriate (e.g., corrective, congratulatory) measures can be taken.

### Project Finance Interest Saver

One of skill in the art would appreciate the cost of financing a project (i.e., the interest derived from a project loan) depends upon the interest rate, the term of the loan, the project cost, and other conditions of the loan agreement. The total cost can be significant if the interest rate, term, and/or the project cost are relatively high. For example, the interest on the project finance can contribute up to 3% of the project cost. Existing methods of calculating the interest on a project loan are estimated at very high levels of approximations. Accordingly, there remains a need for methods of reducing the cost of project financing, including reduction of an interest payment.

In some embodiments, the finance interest saver module 220 is configured to execute a method to reduce the interest burden on a project by adjusting the procurement of products and services and delaying the cashflow, which lowers the interest payment. In some embodiments, the finance interest saver module 220 is configured to calculate the amount of money that can be saved by properly planning and executing any project. In such embodiments, the interest saving calculations are done at a granular, namely for each of the project activities.

In some embodiments, the finance interest saver module 220 categorizes each activity in a project schedule as a Total Float (TF) or a Free Float (FF). In this context, the term “Total Float” is the number of days (or hours) an activity can be delayed without delaying the project completion date. In this context, the term “Free Float” is the number of days (or hours) an activity can be delayed without delaying its successor activity completion date.

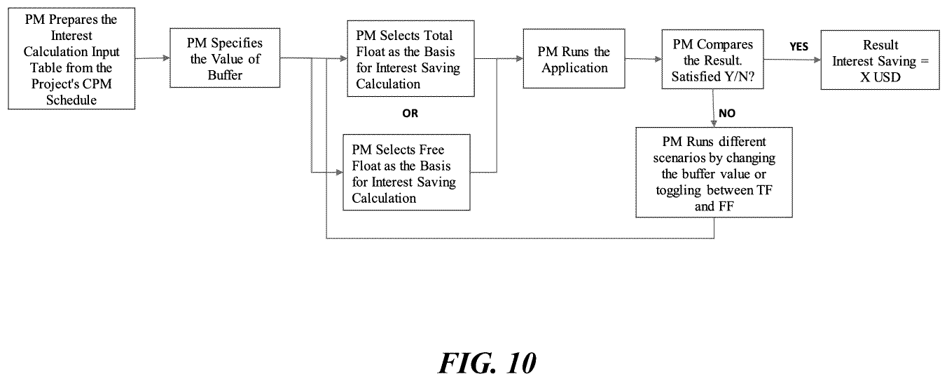

In some embodiments, the process for the Project Finance Interest Saver comprises the steps illustrated in FIG. 10.

In some embodiments, the finance interest saver module 220 provides Table 13 and prompts the user to enter inputs for certain variables. For example, Activity ID, Total Float, Free Float, and Activity Cost are variables derived from a CPM project schedule. In this context, the buffer is the number of days the user (e.g., project manager) wants to use as a protection against any unexpected slippages.

For example, in some embodiments, the user (e.g., project manager) is prompted by the finance interest saver module 220 to select whether the Interest Saving calculation is based on Total Float or Free Float.

If the Project Manager selects Total Float, then the Interest Saving=Saving Goal (in days) multiplied by (*) the Project Finance Interest Rate/(100*365), where Saving Goal=Total Float−Buffer.

If Free Float is selected as the basis for the Interest Saving calculation, then the Interest Saving=Saving Goal (in days) multiplied by (*) the Project Finance Interest Rate/(100*365), where Saving Goal=Total Float−Buffer.

TABLE 13
Interest Calculation Input Table

| | | | | | | |
|---|---|---|---|---|---|---|
| | Total | Free | | Saving | Activity | |
| Activity ID | Float | Float | Buffer | Goal | Cost | Interest Saving |

Activity 1
Activity N

Total

In view of Table 13, a user (e.g., project manager) can execute a plurality of simulations by changing the buffer value, and then settle on a buffer value that provides a good interest saving against a reasonable risk. In general, a lower value for the buffer will result in a higher value of interest saving, but also a higher value in risk, and vice versa.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

I/We claim:

1. A computer implemented method for prioritizing for a current day each respective activity of a plurality of daily activities identified for a project, comprising:
providing an application platform for carrying out the method, wherein the application platform comprises a database with a first list comprising the plurality of daily activities, wherein each respective activity has a plurality of attributes;
identifying each activity of the plurality of daily activities having an early start attribute defined as the current day and storing each of the identified activities in a second list for the current day;
identifying and storing each activity in the second list having a continuing activity attribute and storing the same in a third list for continuing activities for the current day;
identifying and storing each activity in the second list having a non-continuing activity attribute and storing the same in a fourth list for non-continuing activities for the current day;
grading each activity in the third list based on its total float attribute, wherein the grading is one of TF<0; TF=0; and TF>0; and storing the activities for each grade in a fifth list, sixth list, and seventh list, respectively;
grading each activity in the fourth list based on its total float attribute, wherein the grading is one of TF<0; TF=0; and TF>0; and storing the activities for each grade in an eighth list, nineth list, and tenth list, respectively;
identifying each activity in the fifth list having a not breakable attribute and storing the activities in an eleventh list for first highest priority;
identifying each activity in the sixth list having a not breakable attribute and storing the activities in a twelfth list for second highest priority;
identifying each activity in the seventh list having a not breakable attribute and storing the activities in a thirteenth list for third highest priority; and
presenting the activities for the first highest priority, second highest priority, and third highest priority on a user interface according to their respective priority ranking.

2. The method of claim 1, further comprising:
identifying each activity in the eighth list having a not breakable attribute and storing the activities in an eleventh list for fifth highest priority;
identifying each activity in the ninth list having a not breakable attribute and storing the activities in a twelfth list for eighth highest priority;
identifying each activity in the tenth list having a not breakable attribute and storing the activities in a thirteenth list for eleventh highest priority; and
presenting the activities for the fifth highest priority, eighth highest priority, and eleventh highest priority on the user interface according to their respective priority ranking.

3. The method of claim 2, further comprising:
identifying each activity in the fifth list having a breakable attribute and storing the activities in an eleventh list for fourth highest priority;
identifying each activity in the sixth list having a breakable attribute and storing the activities in a twelfth list for seventh highest priority;
identifying each activity in the seventh having a breakable attribute and storing the activities in a thirteenth list for tenth highest priority; and
presenting the activities for the fourth highest priority, seventh highest priority, and tenth highest priority on the user interface according to their respective priority ranking.

4. The method of claim 3, further comprising:
identifying each activity in the eighth list having a breakable attribute and storing the activities in an eleventh list for sixth highest priority;
identifying each activity in the ninth list having a breakable attribute and storing the activities in a twelfth list for ninth highest priority;
identifying each activity in the tenth list having a breakable attribute and storing the activities in a thirteenth list for twelfth highest priority; and
presenting the activities for the sixth highest priority, ninth highest priority, and twelfth highest priority on the user interface according to their respective priority ranking.

5. A computer implemented method for resizing a size, shape, or configuration of an object used in a construction project, comprising:
providing an application platform for carrying out the method, wherein the application platform comprises a resizing engine and a database comprising a plurality of objects, and wherein each object has a plurality of attributes;
presenting the object on a user interface;
identifying one or more attributes of the object for resizing;
applying one or more resize factors to the respective one or more attributes of the object, wherein each respective resize factor is a multiplier;
storing the resized object to the database; and
presenting the resized object on the user interface.

6. The method according to claim 5, wherein a plurality of the one or more attributes of the object are resized in sequence.

7. The method according to claim 5, wherein a plurality of the one or more attributes of the object are resized in parallel.
